(19) United States
(12) Patent Application Publication
(10) Pub. No.: US 2015/0302331 A1
(43) Pub. Date: Oct. 22, 2015

(54) SCHEDULER FOR ATHLETIC FACILITIES

(71) Applicant: Stephen A. Randall, Inver Grove Heights, MN (US)

(72) Inventor: Stephen A. Randall, Inver Grove Heights, MN (US)

(21) Appl. No.: 14/688,929

(22) Filed: Apr. 16, 2015

Related U.S. Application Data
(60) Provisional application No. 61/980,492, filed on Apr. 16, 2014.

(51) Int. Cl. G06Q 10/06

(52) U.S. Cl. CPC G06Q 10/06311

(57) ABSTRACT

A schedule management system for athletic organizations produces an event schedule. The schedule is generated by the system that manages the information involved between the entities. The system accepts properties of an organization, properties of facilities serving the organization, and properties of other related entities. The system processes the properties to generate the schedule. The system can validate the schedule against the properties. The system can further recommend changes to the schedule. The schedule management system uses an interface to enter and modify the properties, to display the schedule, to interact with the validation, and to modify the schedule.

### CROSS REFERENCE TO RELATED APPLICATION(S)

This application claims priority to U.S. Provisional Application Ser. No. 61/980,492, filed Apr. 16, 2014, entitled SCHEDULER FOR ATHLETIC FACILITIES, the disclosure of which is hereby incorporated by reference in its entirety.

### BACKGROUND

Athletic organizations, such as athletic facilities and associations, typically manage limited resources for all of their members, such as athletic associations, teams, and individual members. Thus, athletic organizations prepare their schedules for their members to optimize the available resources among them. Such schedules of athletic organizations need to be designed to eliminate scheduling conflicts and maximize efficiency in time and cost.

### SUMMARY

In general terms, this disclosure is directed to activity schedule management, and more particularly to an activity schedule system for athletic organizations. Various aspects are described in this disclosure, which include, but are not limited to, the following aspects.

One aspect is a method of generating a schedule of one or more athletic facilities for two or more athletic participants. The method may include receiving property data via a user interface of at least one computing device, the property data associated with at least one of the athletic facilities and the athletic participants, and the property data including at least identifications of the athletic facilities, one or more time slots for the athletic facilities, and identifications of the athletic participants; storing the property data in the at least one computing device; generating, using the at least one computing device, assignment data, the assignment data including one or more possible assignments of the athletic participants to at least one of the athletic facilities; scoring, using the at least one computing device, each of the possible assignments; assigning, using the at least one computing device, at least one time slot for at least one of the athletic facilities to at least one of the athletic participants based on the scores of the possible assignments, the assigned time slot being part of the schedule; and providing the schedule to the at least one of the athletic participants.

Another aspect is a system for generating a schedule of an athletic organization for an athletic participant. The system may include a processing device configured to control the system, a user interface, a computer readable data storage device storing software instructions that, when executed by the processing device, cause the system to: receive property data via the user interface, the property data associated with at least one of the athletic facilities and the athletic participants, and the property data including at least identifications of the athletic facilities, one or more time slots for the athletic facilities, and identifications of the athletic participants; store the property data in the at least one computing device; generate assignment data, the assignment data including one or more possible assignments of the athletic participants to at least one of the athletic facilities; score each of the possible assignments; assign at least one time slot for at least one of the athletic facilities to at least one of the athletic participants based on the scores of the possible assignments, the assigned event being part of the schedule; and provide the schedule to the at least one of the athletic participants.

Yet another aspect is a method of generating a schedule of one or more athletic facilities for two or more athletic participants. The method may include storing a database, the database containing data, the data at least including facility identifications, event identifications, activity identifications, and participant identifications; retrieving the data from the database; generating assignment data, the assignment data including one or more possible assignments of the athletic participants to at least one of the athletic facilities; scoring each of the possible assignments; populate the database with the score; assigning at least one time slot for at least one of the athletic facilities to at least one of the athletic participants based on the scores of the possible assignments; populating the database with the at least one time slot; and generate a schedule including the at least one time slot.

### BRIEF DESCRIPTION OF THE DRAWINGS

FIG. 1 diagrammatically illustrates an example system for generating a schedule of an athletic organization for an athletic participant.

FIG. 2 illustrates an exemplary diagram of components involved with the system of FIG. 1.

FIG. 3 illustrates an exemplary diagram of interactions between the components of FIG. 2.

FIG. 4 illustrates that one or more facilities operate as the organizations while one or more associations operate as the participants.

FIG. 5 illustrates that one or more associations operate as the organizations while one or more teams operate as the participants.

FIG. 6 illustrates an exemplary diagram of relationships associated with an assignment.

FIG. 7 illustrates an exemplary diagram of relationships associated with an entity property.

FIG. 8 illustrates an example structure of the system of FIG. 1.

FIG. 9 illustrates an exemplary architecture of a computing device that can be used to implement aspects of the present disclosure.

FIG. 10 illustrates an exemplary architecture of program data that can reside on data store.

FIG. 11 is a flowchart illustrating an example method of operating the schedule management system.

FIG. 12 illustrates an exemplary method for performing the generate events operation.

FIG. 13 illustrates an exemplary method of performing the obtain events operation.

FIG. 14 illustrates an exemplary method of performing the generate combinations operation.

FIG. 15 illustrates an exemplary method of performing the score combinations operation.

FIG. 16 illustrates an exemplary flow of the assign events operation.

FIG. 17 illustrates an exemplary flow of the audit assignments operation.

FIG. 18 illustrates an exemplary flow of the recommend adjustments operation.

FIG. 19 provides an exemplary illustration of the adjust schedule operation.

FIG. 20 is an illustration of an exemplary interface for capturing entity properties.

FIG. 21 is an illustration of an exemplary interface for displaying the information needed for obtaining events.

FIG. 22 is an illustration of an exemplary interface for displaying the information regarding an athletic schedule.

FIG. 23 is an illustration of an exemplary interface for displaying the information regarding an assignment audit.

FIG. 24 is an illustration of an exemplary interface for displaying the recommended adjustments for an athletic schedule.

### DETAILED DESCRIPTION

Various embodiments will be described in detail with reference to the drawings, wherein like reference numerals represent like parts and assemblies throughout the several views.

Whenever appropriate, terms used in the singular also will include the plural and vice versa. The use of “a” herein means “one or more” unless stated otherwise or where the use of “one or more” is clearly inappropriate. Use of the terms “or” or “and” means “and/or” unless otherwise stated or expressly implied by the context in which the word is used. The use of “comprise,” “comprises,” “comprising,” “include,” “includes,” and “including” are interchangeable and not intended to be limiting. The terms “such as,” “for example,” “e.g.,” and “i.e.” also are not intended to be limiting. For example, the term “including” shall mean “including, but not limited to.”

In general, an athletic schedule system according to the present disclosure operates to generate an event schedule for one or more athletic organizations. The athletic schedule system of the present disclosure is configured to obtain and manage information about a plurality of physical resources available at one or more athletic organizations for use by one or more participants, and to efficiently allocate the resources among the participants based on multiple factors. The athletic schedule system can accordingly eliminate or reduce the need for a person to allocate resource and perform scheduling, and eliminates or reduce the potential scheduling bias, conflicts, and mistakes that people can bring to the process. The athletic schedule system also improves efficiency in time and cost as well as increases the efficiency and technical operation of the computers, databases, and other hardware and systems that are used to allocate resources and perform the operations described herein.

In certain examples, the system receives various properties associated with the athletic organizations, such as available time slots at facilities and other properties of the facilities. The system then processes the properties to generate one or more schedules that assign one or more events (e.g., time slots) available at the facilities to one or more participants, so that the participants efficiently utilize the resources of the facilities without conflicts or bias between the participants. In at least some examples, the available events can be allocated among the participants by scoring all possible events (e.g., time slots) for each participant and applying by rules that define how various resources should be allocated.

In at least some embodiments, the system can validate the schedule against the properties. Further, the system can recommend changes to the schedule. The system employs a user interface for enabling the organization to enter and modify the properties, displaying the schedule, interacting with the validation, and modifying the schedule.

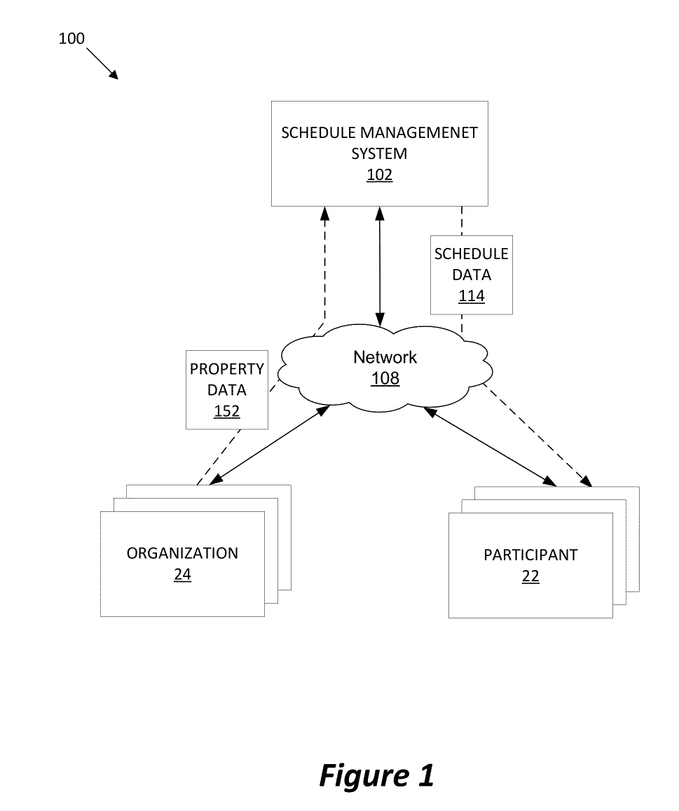

FIG. 1 diagrammatically illustrates an example system 100 for generating a schedule of an athletic organization for an athletic participant. In at least one embodiment, the system 100 includes a schedule management system 102, one or more organizations, and one or more participants 22. Also shown are one or more property data 152 and one or more schedule data 114.

The schedule management system 102 operates to generate one or more schedule data 114 of the organizations 24 for the participants 22. In at least one embodiment, the schedule management system 102 receives the property data 152 from the organizations 24 and process the property data 152 to generate the schedule data 114. As described herein, the schedule data 114 includes a schedule of one or more of the organizations 24 available for each of the participants 22. Further, the schedule data 114 can include a schedule of each of the organizations 24 for more than one of the participants 22.

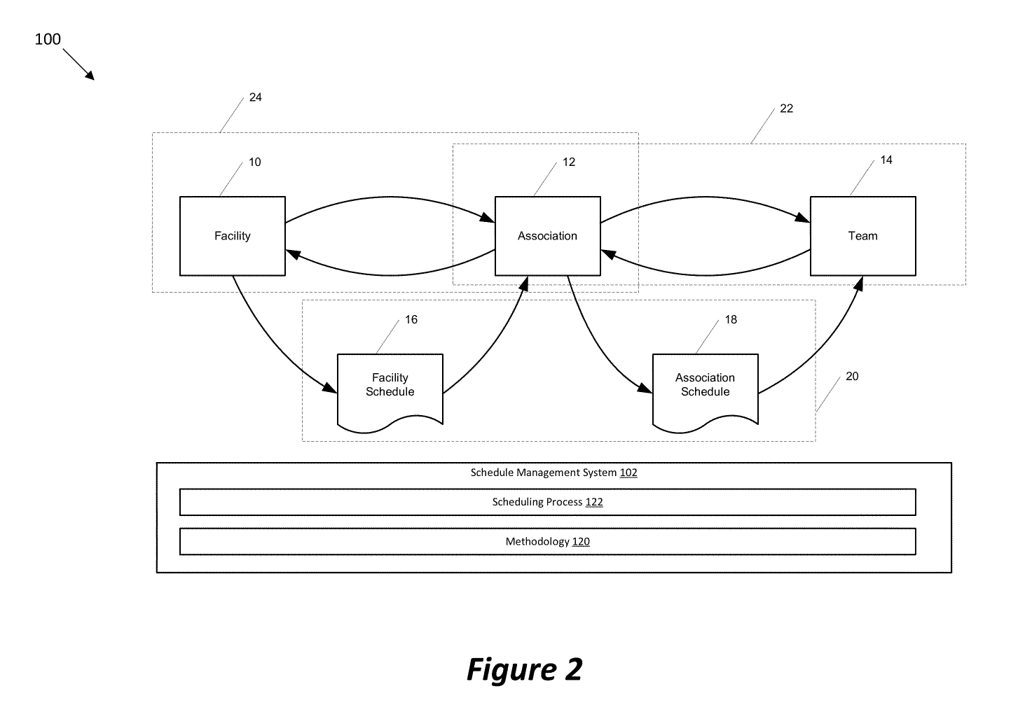

An example of the schedule management system 102 is illustrated and described in more detail with reference to FIGS. 2-19.

The organizations 24 are athletic entities that provide their resources (e.g., athletic fields, tracks, rooms, links, stadiums, and equipment) to the participants 22. As the organizations 24 serve a plurality of the participants 22 with their limited resources at the same time or sequentially, the organizations 24 can optimize their schedules with the schedule management system 102. The organizations 24 can be of various types. Examples of the organizations include athletic facilities 10 and athletic associations 12, which are illustrated and described in more detail with reference to FIGS. 2-4.

The participants 22 are athletic entities that use the resources of the organizations 24 according to the schedules included in the schedule data 114, which are generated by the schedule management system 102. The participants 22 can be of various types. Examples of the participants 22 include athletic associations 12 and athletic teams 14, which are illustrated and described in more detail with reference to FIGS. 2-4.

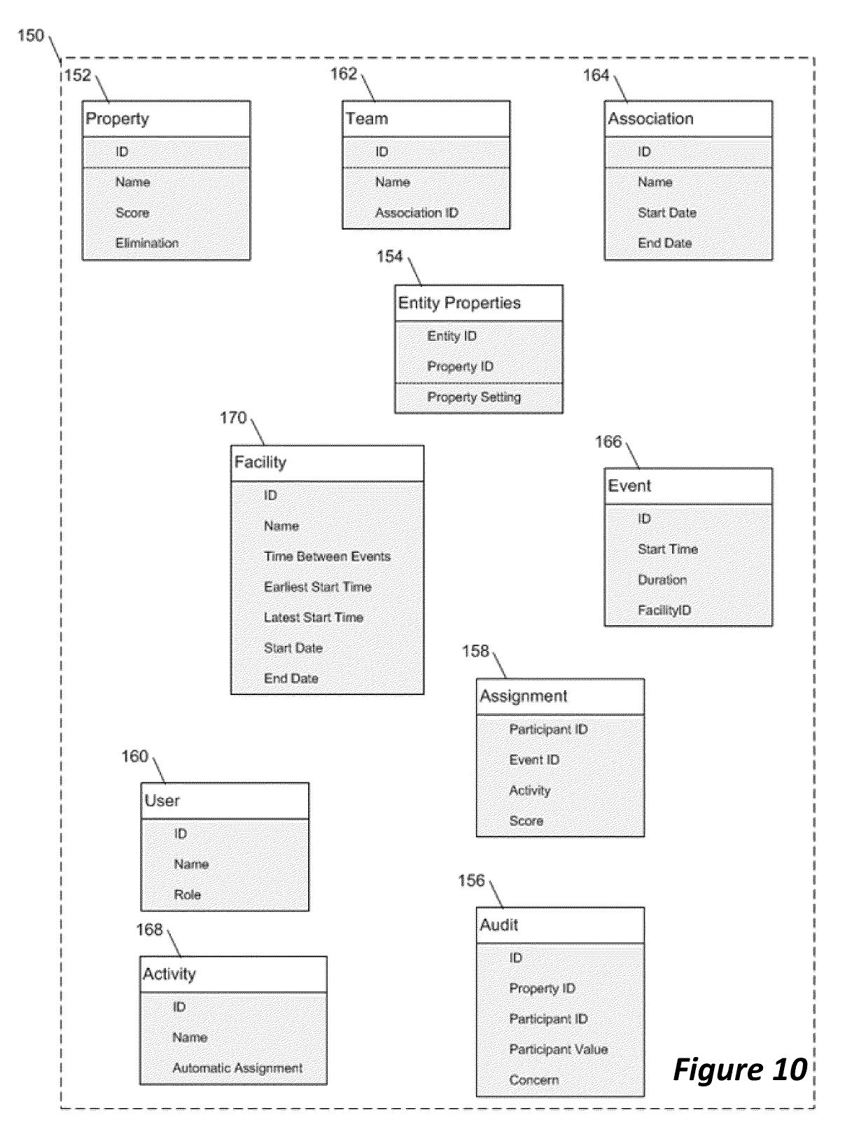

The property data 152 is described in detail with reference to FIG. 10.

In some embodiments, the schedule data 114 includes an athletic schedule 20, which can include a facility schedule 16 and an association schedule 18, as described herein.

FIG. 2 illustrates an exemplary diagram of components involved with the system 100 of FIG. 1. Components, in some embodiments, can include the facility 10, the association 12, the team 14, the facility schedule 16, the association schedule 18, and the athletic schedule 20. As described herein, in different applications, the facility 10 and the association 12 can be the organization 24 while the association 12 and the team 14 can be the participant 22. The schedule management system 102 is configured to execute a methodology 120 and a scheduling process 122 as described herein.

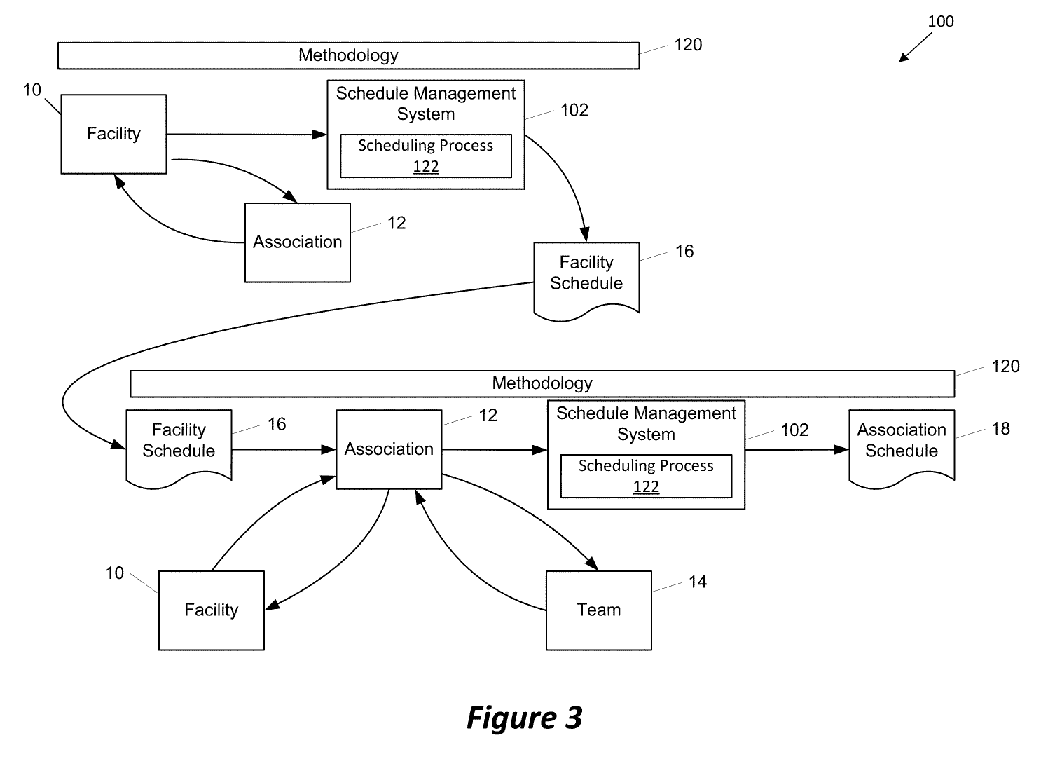

FIG. 3 illustrates an exemplary diagram of interactions between the components of FIG. 2, including the facility 10, the association 12, and the team 14, via the schedule management system 102, which executes the scheduling process 122 to generate the schedule data 114 (such as the facility schedule 16 and the association schedule 18) based upon the methodology 120 as described herein in more detail.

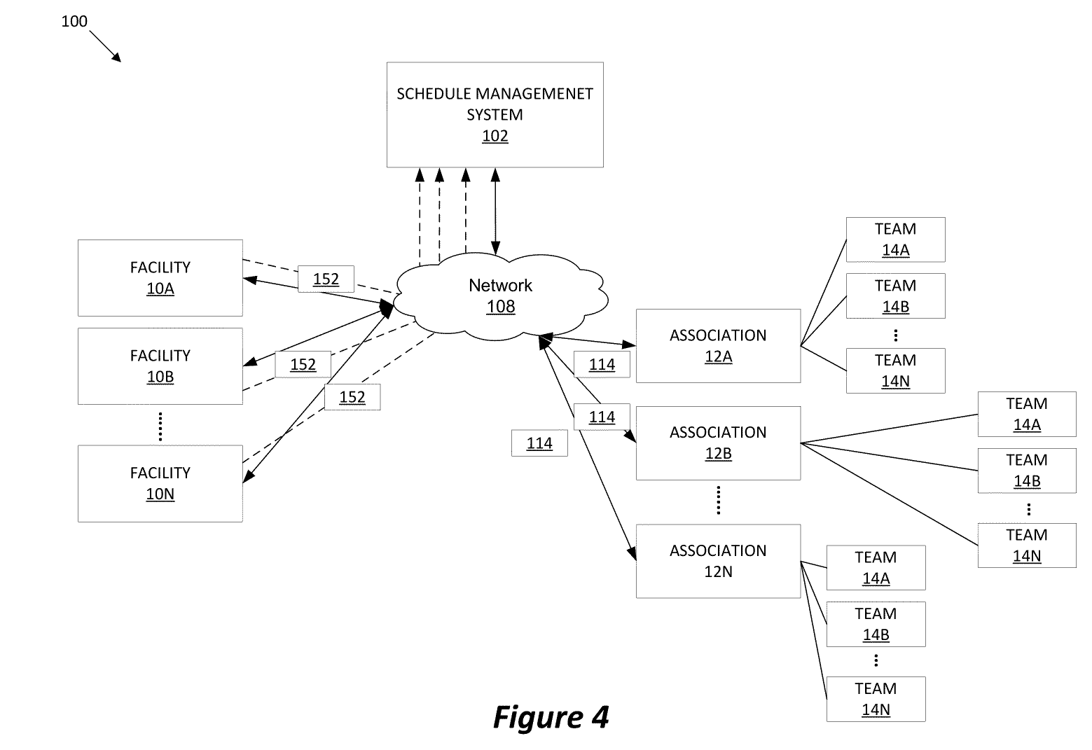

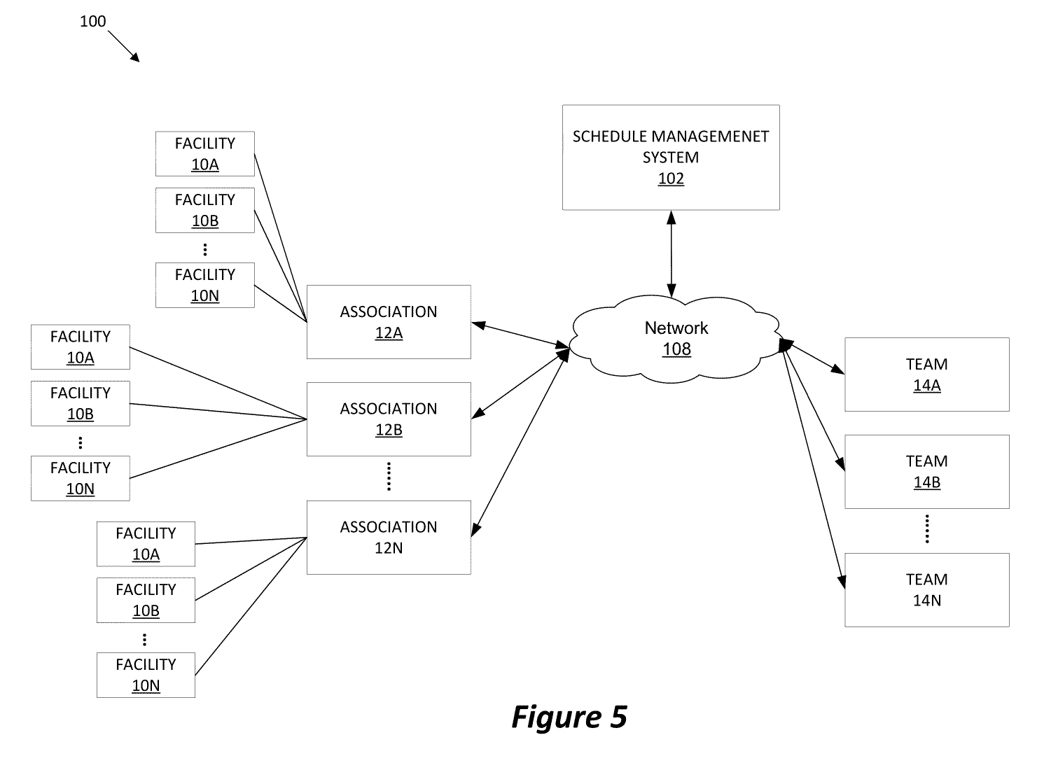

FIGS. 4 and 5 schematically illustrate various embodiments of the system 100 of FIG. 1.

FIG. 4 illustrates that one or more facilities 10 (including 10A-10N) operate as the organizations 24 while one or more associations 12 (including 12A-12N) operate as the participants 22. The schedule management system 102 receives the property data 152 from at least one of the facilities 10 and generates the schedule data 114 for at least one of the associations 12. As described herein, the schedule data 114 include schedules of the facilities 10 available to the associations 12.

The facilities 10 are athletic entities that provide places where the associations 12 can schedule their associated teams 14 (including 14A-14N) to engage in various athletic activities. The facilities 10 can be of various types.

The facilities 10 are athletic entities that provide places where the associations 12 may schedule their associated teams 14 (including 14A-14N) to engage in various athletic activities 44. The facilities 10 can be of various types. The facilities 10 can include, as non-limiting examples, ice rinks, baseball fields, football fields, swimming pools, basketball courts, or other sports facilities. A user (e.g., a manager or operator) of the facility 10 may be responsible for generating a facility schedule 16 of start date/time for which the participants 22 (e.g., the associations 12 and/or the teams 14) may use the facility 10. In at least one embodiment, the user of the facility 10, using the schedule management system 102, can exchange information with the associations 12 to define or provide appropriate property 50 (as the property data 152) for generating the schedule data 114 including a facility schedule 16. In other embodiments, the facilities 10 can exchange information directly or indirectly with the teams 14 to define or provide appropriate property 50 (as the property data 152) for generating the schedule data 114 including the facility schedule 16. As discussed herein, the schedule management system 102 can operate to generate the schedule data 114 including facility schedules 16. In at least one embodiments, the schedule data 152 including facility schedules 16 can be used as input to generating another schedule data 152 including association schedules 18 of the associations 12 available for the teams 14. The facilities 10 can use the schedule management system 102 regardless of whether the associations 12 use the schedule management system 102.

The association 12 can be a recipient of a facility schedule 16 (as a schedule data 114) from one or more facilities 10. In some embodiments, the facility schedule 16 can be used in the schedule management system 102 to generate an association schedule 18. The association 12 can include, as non-limiting examples, athletic associations, athletic leagues, high schools, athletic tournaments, and other athletic organizations. A user (e.g., an officer, manager, administrator, and other employees) of the association 12 can, in some embodiments, be responsible for generating the association schedule 18 (including one or more assignments 48) for its associated team 14 conducting one or more activities 44. Using the schedule management system 102, the associations 12 can receive information from the facilities 10, and can exchange information with the teams 14 to obtain appropriate property 50 for generating an athletic schedule 20. In some embodiments, the association 12 can operate the schedule management system 102 to execute the scheduling process 122 for generating an association schedule 18 (as a schedule data 114). The generated association schedule 18 can be communicated to one or more associated teams 14 as input for their athletic activities 44. The association 12 can operate the schedule management system 102 regardless of whether the facility 10 is using the schedule management system 102. In some embodiments, the schedule management system 102 can receive one or more facility schedules 16 from facilities 10 which do not use the same schedule management system 102.

The team 14 is a participant 22 that is included in the association schedule 18 and can perform the activity 44 at the facility 10 based on the association schedule 18. In some embodiments, the team 14 can receive the association schedule 18 to communicate one or more activities 44 to their individual players using the schedule management system 102. In other embodiments, the team 14 can receive the association schedule 18 in the form of an electronic document, such as a MICROSOFT WORD® document, MICROSOFT EXCEL® spreadsheet, or other electronic format to communicate activity 44 to their individual players. In yet other embodiments, the team 14 can receive an association schedule 18 in the form of integration between the associated schedule management system 102 and any other systems that are used by the team 14.

Referring again to FIGS. 2 and 3, the athletic schedule 20 can include the facility schedule 16 and/or the association schedule 18. As described herein, the athletic schedule 20 is part of the schedule data 114.

The facility schedule 16 is a mechanism within the methodology 120 that communicates available events 46 to the associations 12 for consideration in the association schedule 18. In some embodiments, the facility schedule 16 may take the form of a direct integration within the schedule management system 102 when the facility 10 and the association 12 use the system 102, so that the facility schedule 16 (as the schedule data 114) is directly communicated to the associated facility 10 and/or association 12. In other embodiments, the facility schedule 16 may take the form of integration between the schedule management system 102 and one or more other electronic systems. In yet other embodiments, the facility schedule 16 may take the form of an electronic document, such as a MICROSOFT WORD® document, MICROSOFT EXCEL® spreadsheet, or other electronic format. In yet other embodiments, the facility schedule 16 may take the form of a paper document. In still other embodiments, the schedule management system 102 is configured to communicate data (including the facility schedule 16) with an association 12 that uses a different process or system for generating an athletic schedule 20.

The association schedule 18 is a mechanism within the methodology 120 that communicates one or more assignments 48 for each team 14. In some embodiments, the association schedule 18 is directly communicated to the associated team 14 via the schedule management system 102. In other embodiments, the association schedule 18 can be exported from the schedule management system 100 to other systems for communicating the athletic schedule 20 to the associated team 14. In yet other embodiments, the association schedule 18 may take the form of an electronic document, such as a MICROSOFT WORD® document, MICROSOFT EXCEL® spreadsheet, or other electronic format for distribution to team 14. In some embodiments, the association schedule 18 may be communicated within the system 100 to the associated facility 10. In yet other embodiments, the association schedule 18 may be communicated from the schedule management system 102 to the facility 10 using an electronic document, such as a MICROSOFT WORD® document, MICROSOFT EXCEL® spreadsheet, or other electronic format not illustrated. In still other embodiments, the association schedule 18 may be communicated from the schedule management system 102 to the facility 10 that uses another system.

With continued reference to FIGS. 2 and 3, the scheduling process 122 can be a scheduling engine that accepts and processes information from the facilities 10, the associations 12, and the teams 14 to generate one or more athletic schedules 20. The scheduling process 122 can, in some embodiments, generate possible dates and times to be considered for one or more assignments 48 to the associations 12 and/or teams 14. As described herein, the scheduling process 122 can, in some embodiments, calculate a numerical score based on a combination 52 to prioritize in generating athletic schedules 20. In other embodiments, the scheduling process 122 can prioritize the combination 52 based on the properties 50 of events 46, participants 22, facilities 10, associations 12, teams 14, or other entities 56. The schedule management system 102 executes the scheduling process 122. In some embodiments, upon schedule generation, the system 102 can recommend schedule adjustments that can be made.

The assignment combination 52 can represent possible assignment 48 that could be used by the schedule management system 102 during various operations (e.g., assign events operation 136 and adjust schedule operation 142). The assignment combination 52 can include entity 56, such as, for non-limiting examples, participant 22, activity 44, and event 46.

The methodology 120 can be an overall framework executed by the schedule management system 102 to, for example, gather information, communicate needs, generate athletic schedules 20, and review assignments from start to finish for the organization 24. As described herein, the methodology 120 can include an audit assignments operation 138, an adjust schedule operation 142, and other suitable methods or processes. In some embodiments, the schedule management system 102 executing the methodology 120 can be managed and/or operated by the facility 10 and/or the association 12. In yet other embodiments, the methodology 120 can be executed by a schedule management systems 102 used by the facility 10 and by another schedule management system 102 used by the association 12. In still other embodiments, the methodology 120 can be executed by a schedule management systems 102 used by the association 12 and by another schedule management system 102 used by the facility 10.

FIG. 5 illustrates that one or more associations 12 (including 12A-12N) operate as the organizations 24 while one or more teams 14 (including 14A-14N) operate as the participants 22. The schedule management system 102 receives the property data 152 from at least one of the associations 12 and generates the schedule data 114 for at least one of the teams 14. As described herein, the schedule data 114 include schedules of the facilities 10 available to the teams 14.

As shown herein, the participants 22 can represent the associations 12 and/or the teams 14. In other embodiments, the participants 22 can include the facilities 10 where the facilities 10 have schedules (e.g., assignments 48) for their own activities 44 or for other facilities 10. As shown above, the association 12 can represent both an organization 24 that generates an association schedule 18 and a participant 22 that is included in a facility schedule 16.

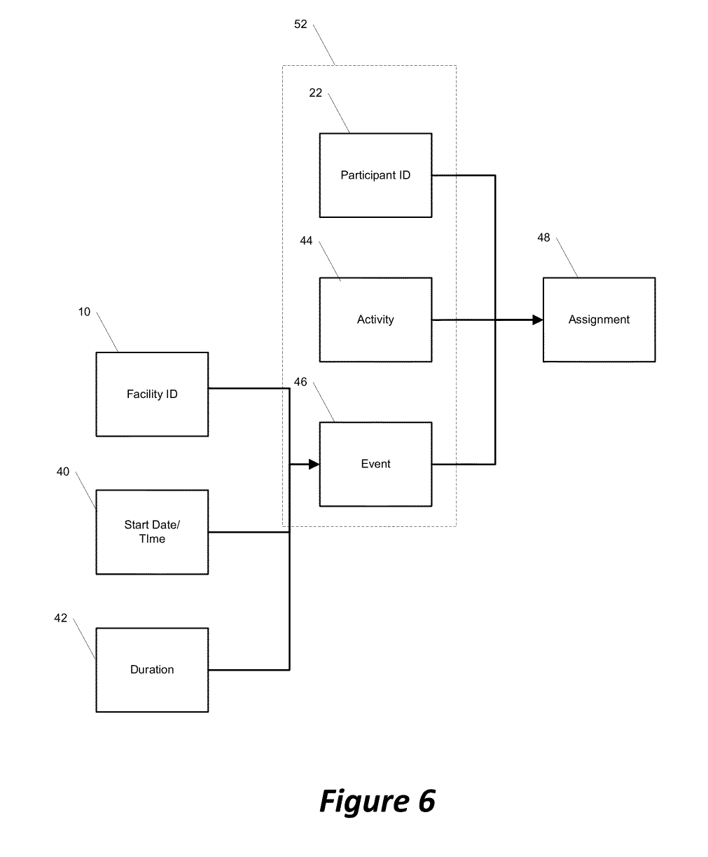

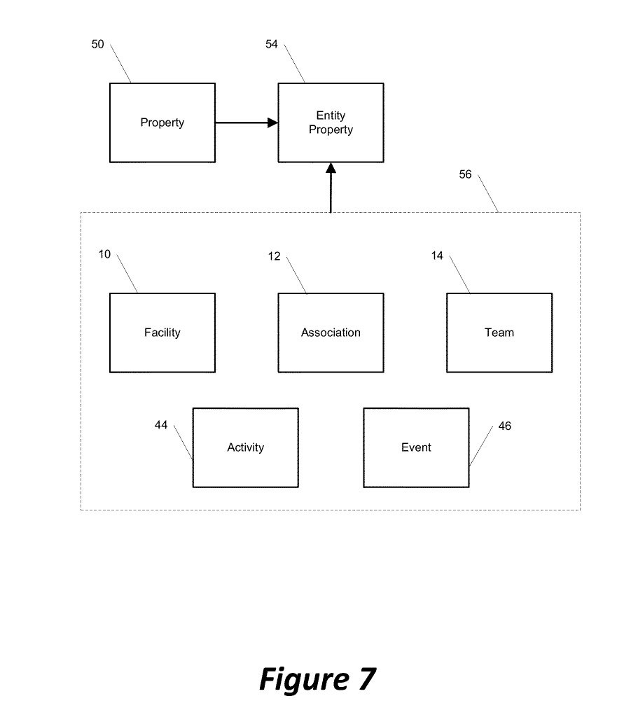

Referring now to FIGS. 6 and 7, example relationships between data involved in the system 100.

FIG. 6 illustrates an exemplary diagram of relationships associated with an assignment 48. The assignment 48 represents information of assigning at least one time slot for at least one organization 24 (e.g., the facilities 10), which is available to at least one participant 22 (e.g., the associations 12 and/or the teams 14). The assignment 48 is determined by the schedule management system 102 based on a combination 52 of various pieces of information.

In at least some embodiments, the combination 52 includes identifications of the participants 22 (i.e., participant IDs), one or more types of activities 44, and one or more events 46 (i.e., time slots).

The identifications of the participants 22 are information for identifying the participants 22. As described herein, the participants 22 can be the associations 12 or the teams 14. In other applications, the participants 22 can be the facilities 10.

The activities 44 represent actions and/or performances which are conducted at the facilities 10 during the events 46 by the participants 22. The activities 44 include, as non-limiting examples, game, solo practice, shared practice, away game, tournament, or other applicable activity 44. In some embodiments, the activities 44 are not used in the combination 52 where, for a non-limiting example, all of the events 46 have the same activity 44.

The events 46 can represent time slots available at one or more certain facilities 10 for one or more activities 44 to be performed by one or more associated participants 22. In at least one embodiment, each event 46 is determined based on a combination of identifications of the facilities 10, start date/time 40, and duration 42. In some embodiments, the events 46 provide summary information for where a participant 22 can conduct its activity 44. In other embodiments, the event 46 does not include identifications of the facilities 10 where, for a non-limiting example, there is only one facility 10 available. In yet other embodiments, the event 46 does not include duration 42 where, for a non-limiting example, all events 46 have the same duration 42. In still other embodiments, the event 46 does not include start date/time 40 where, for a non-limiting example, end date/time is used instead.

The identifications of the facilities 10 (i.e., facility IDs) are information for identifying the facilities 10.

The start date/time 40 represents the date and time that the participant 22 may begin using the facility 10 for the event 46. In some embodiments, the start date/time 40 may contain details of the end time and/or date for the event 46. In other embodiments, the start date/time 40 can be replaced when the end date/time is instead used to determine an event 46.

The duration 42 represents a length of time that the facility 10 offers to the participant 22 to conduct its activity 44. The duration 42 can, as non-limiting examples, be a number of minutes, a number of hours, a number of days, fractions of days, fractions of hours, or any other application length of time.

In at least some embodiments, the assignment 48 represents a combination of the identification of one or more participants 22, an activity 44, and an event 46. The assignment 48 provides information for the athletic schedule 20 (i.e., the schedule data 114) of when, where, and what will be conducted at the associated facility 10. In some embodiments, the assignment 48 can have one or more participants 22, one or more activities 44, and/or one or more events 46 where, for non-limiting examples, one or more participants 22 share one or more events 46 with one or more other participants 22 or where one or more participants 22 share one or more events 46 with one or more other participants 22 for different activities 44.

FIG. 7 illustrates an exemplary diagram of relationships associated with an entity property 54. The entity property 54 represents information or characteristics of one or more entities 56 in the system 100. In some embodiments, the entities 56 include the facilities 10, the associations 12, and the teams 14. In addition, other embodiments of the entities 56 include information about activities 44 and/or events 46 associated with the facilities 10, the associations 12, and/or the teams 14. As described herein, the entity property 54 is used in various processes (e.g., an assign events operation 136, an audit assignments operation 138, or an adjust schedule operation 142) performed by the schedule management system 102.

For non-limiting examples, the property 50 can include a maximum number of events 46 per day for a participant 22, the unit of measure for duration 42, a required activity 44 for a participant 22, a minimum start time for a facility 10, and other appropriate characteristics for the entity 56. In some embodiments, the entity property 54 includes the property 50, and is used in various processes of the schedule management system 102 as described herein.

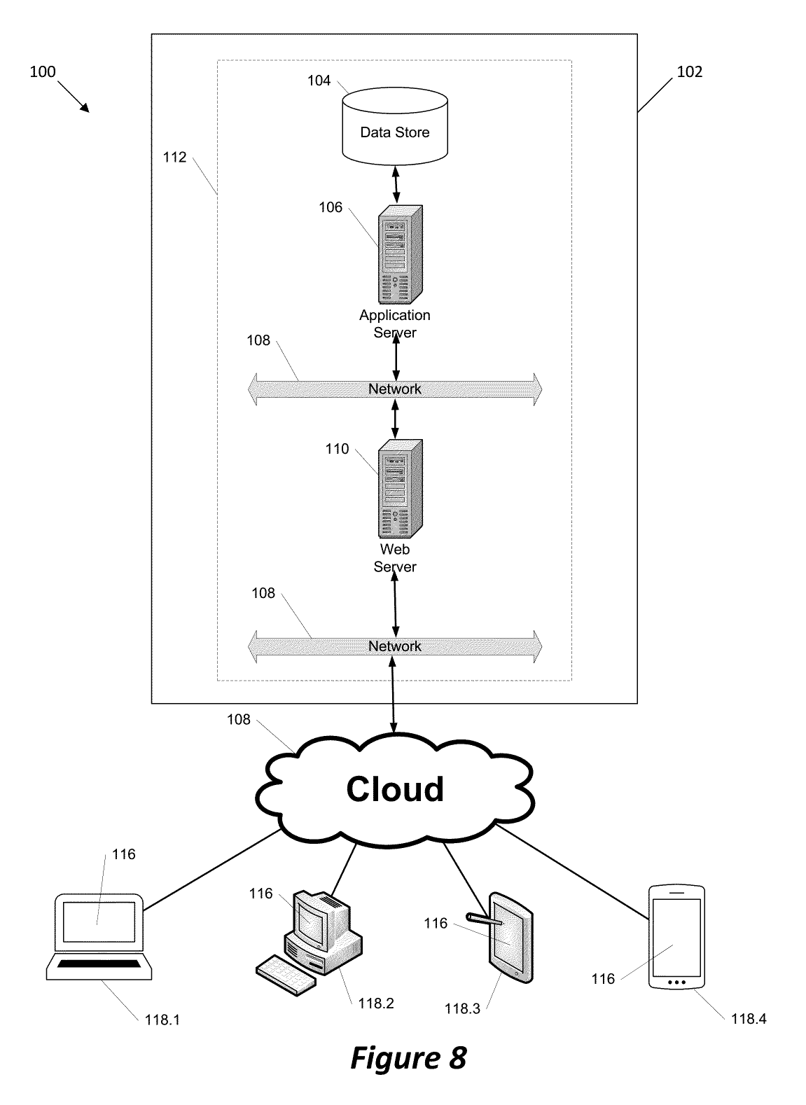

FIG. 8 illustrates an example structure of the system 100 of FIG. 1. In some embodiments, the system 100. In some embodiments, the schedule management system 102 includes data store 104, user interface 116, and application program 112 that can, as non-limiting examples, execute methodology 120, execute scheduling process 122, manage information between entity 56, generate athletic schedule 20, execute audit assignments method 138, and provide an apparatus for review and adjust schedule method 142. The system 100, in some embodiments, can include, as non-limiting examples, application program 112, network 108, and client 118. Client 118 can include, as non-limiting examples, laptops 118.1, desktops 118.2, tablets 118.3, and phones 118.4 connected to network 108.

Some embodiments of application program 112 can include network 108, web server 110, application server 106, and data store 104. Application program 112 can operate to store and provide selected data and display information across network 108. Application program 112 can be located at the same location such as in the same room, building or facility as one or more client 118. Alternatively, application program 112 can be located remote from client 118, such as in a different building, city, state, country, or continent.

Data store 104 can be a data storage device configured or programmed to store and retrieve information. Non-limiting examples of a possible data store 104 include a hard disk drive, a collection of hard disk drives, digital memory such as random access memory or read only memory, a redundant array of independent disks RAID or other data storage devices. In some embodiments, information can be distributed across multiple local or remote data storage devices. Data store 104 can maintain the data in an organized manner, such as in a hierarchical or relational database structure. Although data store 104 is illustrated separate from client 118 by application server 106, network 108, and web server 110, data store 104 can be alternatively a local data storage device of client 118 or can be connected to the same network 108 as client 118.

Application server 106 can be configured or programmed to access data store 104 and communicate information retrieved. In one example embodiment, application server 106 can be a computing device that can include a database software application, such as SQL SERVER® database software distributed by MICROSOFT® Corporation. When a request is received by application server 106, application server 106 retrieves information from data store 104 and sends it across network 108 and web server 110 to client 118 that requested it. In some other possible embodiments, application server 106 can be separate from data store 104 and can be configured or programmed to access data store 104 using network 108. In some other possible embodiments, application server 106 can be separate from data store 104 and can be configured or programmed to access data store 104 remotely using network 108.

Some alternative embodiments do not include application server 106, and instead, client 118 can be configured or programmed to retrieve information directly from data store 104. Some alternative embodiments do not include application server 106, and instead, web server 110 can be configured or programmed to retrieve the information directly from data store 104 upon receiving a request from client 118. Some alternative embodiments combine application server 106 and data store 104 that can be configured to receive requests. Some alternative embodiments can include one or more application server 106 that can be configured or programmed to retrieve information from data store 104.

Network 108 communicates digital data between one or more computing devices, such as between application server 106 and web server 110 or between application server 106 and data store 104. Non-limiting examples of network 108 include a local area network, and a wide area network, such as the Internet.

In some embodiments, network 108 can include a wireless communication system, a wired communication system, or a combination of wireless and wired communication systems. A wired communication system can transmit data using electrical or optical signals in various possible embodiments.

Web server 110 can be configured or programmed to receive a request from client 118 and communicate the request to application server 106. When web server 110 receives a request, web server 110 can be configured or programmed to send the appropriate data from the request to application server 106 over network 108. Web server 110 can be configured or programmed to receive a response from application server 106 and communicate the response to client 118. When web server 110 receives a response, web server 110 can be configured or programmed to send the appropriate data from application server 106 response with the appropriate display details to client 118 over network 108. In some other possible embodiments, web server 110 can be local to application server 106 and can be configured or programmed to access application server 106 without using network 108. In some other possible embodiments, web server 110 can be separate from application server 106 and can be configured or programmed to access application server 106 remotely using network 108.

Some alternative embodiments do not include web server 110, and instead, client 118 can be configured or programmed to retrieve information directly from application server 106. Some alternative embodiments combine web server 110 with application server 106, and the combined server can be configured or programmed to communicate with client 118 and data store 104. Some alternative embodiments include one or more web server 110 that can be configured or programmed to receive requests from client 118 and communicate with application server 106.

In some embodiments, user interface 116 can be provided to client 118 from application program 112 through network 108. User interface 116 can, in some embodiments, be the same interface for laptops 118.1, desktops 118.2, tablets 118.3, and phones 118.4. In some alternative embodiments, user interface 116 can be different for laptops 118.1, desktops 118.2, tablets 118.3, or phones 118.4.

In some embodiments, client 118 can be computing devices that are used by organization 24 that can display a different user interface that communicates with application program 112 to get the information to be displayed. Organization 24 may include, as non-limiting examples, athletic facilities, teams, associations, managers, leagues, districts, regions, states or other people or groups involved with managing athletic schedule 20.

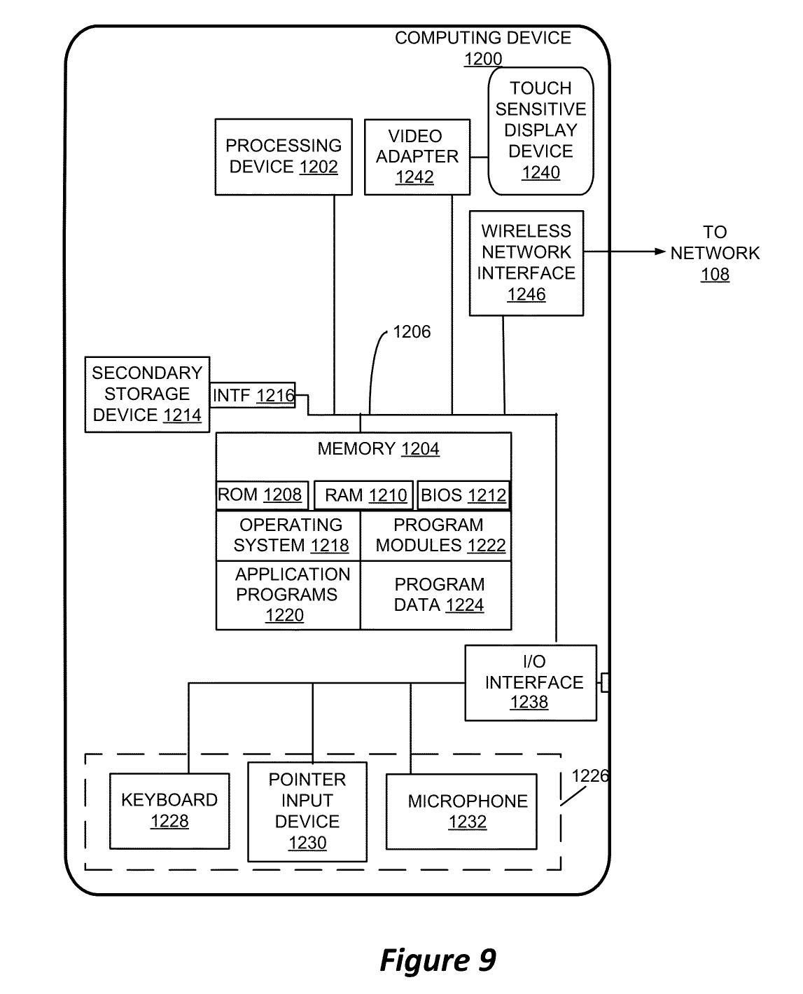

FIG. 9 illustrates an exemplary architecture of a computing device that can be used to implement aspects of the present disclosure, including the schedule management system 102 and the clients 118, and will be referred to herein as the computing device 1200. The computing device 1200 is used to execute the operating system, application programs, and software modules (including the software engines) described herein.

The computing device 1200 includes, in some embodiments, at least one processing device 1202, such as a central processing unit (CPU). A variety of processing devices are available from a variety of manufacturers, for example, Intel or Advanced Micro Devices. In this example, the computing device 1200 also includes a system memory 1204, and a system bus 1206 that couples various system components including the system memory 1204 to the processing device 1202. The system bus 1206 is one of any number of types of bus structures including a memory bus, or memory controller; a peripheral bus; and a local bus using any of a variety of bus architectures.

Examples of computing devices suitable for the computing device 1200 include a desktop computer, a laptop computer, a tablet computer, a mobile device (such as a smart phone, an iPod® mobile digital device, or other mobile devices), or other devices configured to process digital instructions.

The system memory 1204 includes read only memory 1208 and random access memory 1210. A basic input/output system 1212 containing the basic routines that act to transfer information within computing device 1200, such as during start up, is typically stored in the read only memory 1208.

The computing device 1200 also includes a secondary storage device 1214 in some embodiments, such as a hard disk drive, for storing digital data. The secondary storage device 1214 is connected to the system bus 1206 by a secondary storage interface 1216. The secondary storage devices and their associated computer readable media provide nonvolatile storage of computer readable instructions (including application programs and program modules), data structures, and other data for the computing device 1200.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 1214 or memory 1204, including an operating system 1218, one or more application programs 1220, other program modules 1222, and program data 1224.

In some embodiments, computing device 1200 includes input devices to enable a user to provide inputs to the computing device 1200. Examples of input devices 1226 include a keyboard 1228, pointer input device 1230, microphone 1232, and touch sensitive display 1240. Other embodiments include other input devices 1226. The input devices are often connected to the processing device 1202 through an input/output interface 1238 that is coupled to the system bus 1206. These input devices 1226 can be connected by any number of input/output interfaces, such as a parallel port, serial port, game port, or a universal serial bus. Wireless communication between input devices and interface 1238 is possible as well, and includes infrared, BLUETOOTH® wireless technology, 802.11a/b/g/n, cellular, or other radio frequency communication systems in some possible embodiments.

In this example embodiment, a touch sensitive display device 1240 is also connected to the system bus 1206 via an interface, such as a video adapter 1242. The touch sensitive display device 1240 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs.

In addition to the display device 1240, the computing device 1200 can include various other peripheral devices (not shown), such as speakers or a printer.

When used in a local area networking environment or a wide area networking environment (such as the Internet), the computing device 1200 is typically connected to the network through a network interface, such as a wireless network interface 1246. Other possible embodiments use other communication devices. For example, some embodiments of the computing device 1200 include an Ethernet network interface, or a modem for communicating across the network.

The computing device 1200 typically includes at least some form of computer-readable media. Computer readable media includes any available media that can be accessed by the computing device 1200. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 1200.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

FIG. 10 illustrates an exemplary architecture of program data 150 that can reside on data store 104. In at least some embodiments, the program data 150 include property data 152, entity property data 154, audit data 156, assignment data 158, user data 160, team data 162, association data 164, event data 166, activity data 168, and facility data 170. In other embodiments, the program data 150 can include more or fewer data tables.

In an exemplary embodiment, the data stored in the program data 150 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally the data can be represented using formats other than those conforming to a markup language.

The property data 152, in some embodiments, can include a list of one or more available properties 50. The property 50 can, in some embodiments, be mapped to a unique property key, which can be used to refer to the property 50 in other data structures. The property 50 identifies characteristics of the entity 56, such as, for non-limiting examples, the team 14, the association 12, and/or the facility 10. In some embodiments, the property 50 can include dates applicable to the entity 56, counts of event 46 applicable to the entity 56, event 46 that cannot be scheduled for the entity 56, or event 46 that must be scheduled for the entity 56, such as, for non-limiting examples, team start date, association maximum solo practice count, facility earliest start time, or other applicable properties. Some embodiments can include the property data 152 with more than 500 properties 50. In some embodiments, the property 50 is not mapped to all available entities 56. By way of non-limiting example, in some applications, the facility 10 does not have any property 50 defined. In some embodiments, the property 50 can be stored in the data store 104 for all entities 56 in a single table. In some embodiments, the property 50 can be stored in the data store 104 in one or more tables for applicable entities 56. In some embodiments, details, as illustrated in FIG. 10, may be stored as the property 50 for entity 56. By way of a non-limiting example, start date/time 40 can be maintained as property information for a facility 10, or activity 44 can be maintained as property information for an assignment 48.

In some embodiments, the property 50 can be organized in a hierarchical structure that provides various levels of abstraction thereof. By way of example, a hierarchical structure can include multiple levels, where the property 50 in the first level are assigned to entity 56, such as team 14, association 12, and facility 10, while a second level property 50 can be assigned a specific detail for entity 56. For a non-limiting example, a first level property 50 might be team 14, while a second level property 50 might be start date. Additional data structures can be provided in some embodiments to link property 50 to various levels in a hierarchical structure. Some embodiments can associate each property 50 with a category, such as by including a category column not illustrated in property data 152. Non-limiting examples of property 50 categories include a sport; entity type; and a data type, such as integer, date, or other application data type. Other embodiments include more or fewer property categories.

The property data 152, in some embodiments, can include details about property 50, such as a name, a score, or elimination flag. The property details contain additional information that can, in some embodiments, be configured and programmed into the system 102 for processing within the data store 104, processing within the application server 106, or processing within the web server 110. Other embodiments can include more or fewer property details. Score can be one or more numerical values that indicate the relative importance of the property 50 when generating an athletic schedule 20. In some embodiments, there can be one score detail in the property data 152. In some alternative embodiments, for non-limiting example, there can be one score field for each possible comparison between a property setting detail of the entity property data 154 and a participant value detail of the audit data 156 (e.g., where a property setting is less than a participant value, where a property setting is greater than a participant value, or where a property setting is equal to a participant value). In some alternative embodiments, for non-limiting example, there can be one score detail for a participant value detail of the audit data 156 that is true and one score detail for a participant value detail of the audit data 156 that is false. In some embodiments, an elimination flag of the property data 152 can be used by the application program 112 to determine which team 14 and combination 52 can be eliminated from consideration for an assignment 48. In some alternative embodiments, an elimination flag detail of the entity property data 154 can be maintained by a special value in the assignment combination 52 score detail. By way of non-limiting example, a large negative number indicates elimination. In some alternative embodiments, an elimination flag detail of the entity property data 154 is not maintained in the data store 104.

The team data 162, in some embodiments, can include a list of available team 14. The team 14 identifies who may be performing activity 44 at facility 10 during event 46 The team 14 can include, as non-limiting examples, teams, clubs, leagues, individuals, groups of individuals, associations, groups of associations, or other types of facility 10 users. The team data 162 can, in some embodiments, be mapped to a unique team key, which can be used to refer to the team 14 in other data structures.

In some embodiments, the team data 162 can be organized in a hierarchical structure that provides various levels of abstraction therefor. As a non-limiting example, a hierarchical structure can include multiple levels, where team 14 in the first level are assigned to a group of team 14, such as specific athletic team level, while a second level property can be assigned a specific team 14. For non-limiting example, a first level team 14 might be Bantam hockey teams, while a second level team 14 might be a Bantam A team. Additional data structures can be provided in some embodiments to link team 14 to the various levels in a hierarchical structure. Some embodiments further associate team 14 with a category, such as by including a category column not illustrated in team data 162. Non-limiting examples of team categories include a sport, an age group, a league, and other team categories. Other embodiments include more or fewer team categories.

The team data 162, in some embodiments, can include details about team 14, such as a name, association, or other details. Details of the team data 162 contain additional information that can, in some embodiments, be configured or programmed into the system 102 for processing within the data store 104, processing within the application server 106, and processing within the web server 110. Other embodiments can include more or fewer team data details.

The association data 164, in some embodiments, can include a list of association 12. The association 12 can, in some embodiments, represent a group of team 14 that can have similar property 50. The association 12 can include individuals, groups of individuals, other association 12, groups of association 12, or other facility participants 22. The association data 164 can be mapped to a unique association key, which can be used to refer to the association 12 in other data structures. In some embodiments, the association 12 can be categorized with one or more categories, such as by including a category column not illustrated in the association data 164. Non-limiting examples of association data categories can include a sport, a league, facility, or other applicable category. In some alternative embodiments, the association 12 can be included as the highest level of team 14 in the team data 162.

The association data 164, in some embodiments, can include details about association 12, such as a name, a start date, an end date, or other details. Details of the association data 164 contain additional information that can, in some embodiments, be configured or programmed into the application program 112 for processing within the data store 104, processing within the application server 106, and processing within the web server 110. Other embodiments can include more or fewer association data details. In some alternative embodiments, the association data details can be stored within the property data 152. By way of non-limiting example, start date can be maintained as property 50 instead of as association data detail.

The event data 166, in some embodiments, can include a list of available events 46. The event 46 identifies when participant 22 may be performing activity 44. The event data 166 can be mapped to a unique event key, which can be used to refer to the event 46 in other data structures. Some embodiments further associate event 46 with a category, such as by including a category column not illustrated in the event data 166. Non-limiting examples of event categories include, a sport, a time of day, a day of week, or other event categories.

The event data 166, in some embodiments, can include details about event 46, such as a start time, a duration 42, facility 10, or other event 46 details. Event data 166 details contain additional information that can, in some embodiments, be configured or programmed into system 100 for processing within data store 104, processing within application server 106, and processing within web server 110. Other embodiments can include more or fewer event data 166 details.

The activity data 168 can, in some embodiments, include a list of available activity 44. The activity 44 identifies what action participant 22 may be performing during event 46. The activity data 168 can be mapped to a unique activity key, which can be used to refer to the activity 44 in other data structures. Some embodiments may associate activity 44 with a category, such as by including a category column not illustrated in the activity data 168. Non-limiting examples of activity categories include manual, automated, a specific organization 24, or other applicable category.

The activity data 168 can, in some embodiments, include details about activity 44, such as a name, an automatic assignment flag, or other activity details. The activity data details contain additional information that can, in some embodiments, be configured or programmed into the system 102 for processing within the data store 104, processing within the application server 106, and processing within the web server 110. Other embodiments can include more or fewer activity data details.

The facility data 170, in some embodiments, can include a list of available facility 10. The facility 10 identifies where participant 22 may be performing activity 44. The facility data 170 can be mapped to a unique facility key, which can be used to refer to the facility 10 in other data structures. Some embodiments further associate facility 10 with a category, such as by including a category column not illustrated in facility data 170. Non-limiting examples of facility categories include, as non-limiting examples, a sport, a city, a state, a country, or other applicable category.

The facility data 170, in some embodiments, can include details about facility 10, such as a name, a time between events, earliest start time, latest start time, start date, end date, or other details. The facility data details contain additional information that can, in some embodiments, be configured or programmed into the application program 112 for processing within the data store 104, processing within the application server 106, and processing within the web server 110. Other embodiments include more or fewer facility data details. In some embodiments, a time between events detail of the facility data 170 can be used to determine the amount of time that must be maintained between the end of one event 46 and the start of another event 46. In some embodiments, an earliest start time detail of the facility data 170 and a latest start time detail of the facility data 170 can be used to maintain the appropriate times that the facility 10 may be available. In some embodiments, the start date detail and end date detail can be used to maintain the appropriate dates that the facility 10 may be available.

The user data 160, in some embodiments, can include a list of available users. The user identifies the individuals that can access user interface 116 on client 118. The user data 160 can be mapped to a unique user key, which can be used to refer to user in other data structures. Users can, as non-limiting examples, include facility schedulers, association schedulers, team managers, board members, facility employees, committee members, coaches, parents, and other consumers of athletic schedule 20. User access to information and functionality can, in some embodiments, be restricted based upon their role in generating, reviewing, or distributing athletic schedule 20.

The user data 160, in some embodiments, can include details about user, such as a name, a role, and other user details. The user data details contain additional information that can, in some embodiments, be configured or programmed into application program 112 for processing within data store 104, processing within application server 106, and processing within web server 110. Other embodiments include more or fewer user data 160 details. In some embodiments, user data 160 role detail can be used by application program 112 to determine the appropriate data and interfaces to display for user. In some alternative embodiments, user data 160 role details may not be maintained in data store 104, user data 160, application program 112, or other data source.

The entity property data 154 links entity 56, including, as non-limiting examples, facility 10, association 12, team 14, to applicable property data 152. In some embodiments, the entity property data 154 can be mapped to a unique key, which can be used to refer to the entity property 54 in other data structures. As non-limiting examples, the entity property data 154 can, in some embodiments, include a list of combinations of team data 162 with property data 152, a list of combinations of association data 164 with property data 152, a list of the combinations of association data 164 and team data 162 with property data 152, or other appropriate combinations of entity and property data. In some embodiments, the entity property unique key can be a combination of multiple keys, such as, for a non-limiting example, team data unique key and property data unique key.

The entity property data 154 may include details about entity property 54, such as property setting or other applicable details. The entity property data details contain additional information that can, in some embodiments, be configured or programmed into application program 112 for processing within data store 104, processing within application server 106, and processing within web server 110. Other embodiments include more or fewer entity property data details. The property setting of the entity property data 154 can, for a non-limiting example, be a numerical value, such as, ten for a solo practice count property, or true for a Saturday required property.

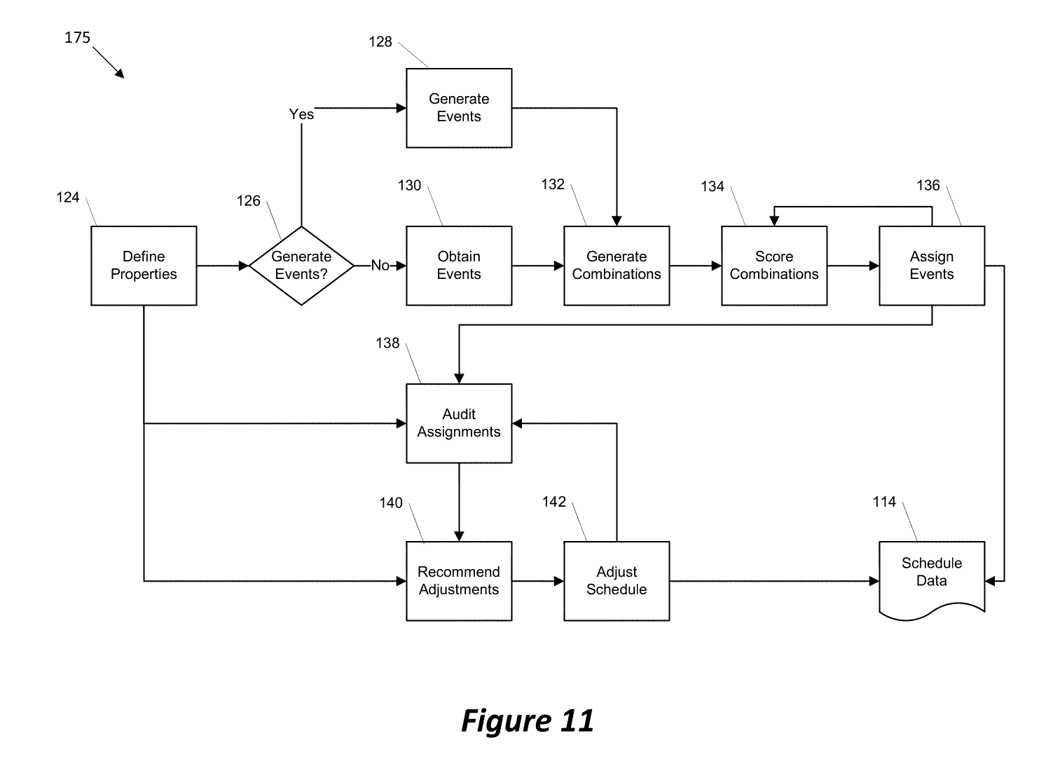

The assignment data 158, in some embodiments, can include a list of assignment 48 generated by an assign events operation 136 (FIG. 11). The assignment data 158 links participant 22 and activity data 168 to event data 166 as illustrated above as a non-limiting example. In some other embodiments, the assignment data 158 can include, as non-limiting examples, a list of combinations of association data 164 and activity data 168 with event data 166; a list of combinations of team data 162 and activity data 168 with event data 166, or other lists that link entity 56 to assignment 48. In some embodiments, assignment data 158 maps each combination to a unique assignment key. In some embodiments, the assignment data unique key can be a combination of multiple keys, such as, for non-limiting example, team data unique key and event data unique key. In some embodiments, the assignment data unique key can be used to refer to the assignment 48 in other data structures.

The assignment data 158, in some embodiments, can include details about assignment 48, such as, as non-limiting examples, team 14, event 46, activity 44, score, or other details. Assignment data details contain additional information that can, in some embodiments, be configured or programmed into application program 112 for processing within data store 104, processing within application server 106, and processing within web server 110. Other embodiments can include more or fewer assignment data details. In some embodiments, an activity detail of the assignment data 158 can store the action that participant 22 is conducting during event 46, such as a game, practice, tournament, or other applicable activity 44. In some embodiments, the activity detail of the assignment data 158 will not be maintained within data store 104 or assignment data 158 where, for non-limiting example, only one activity 44 is available and does not therefore need to be maintained in assignment data 158.

The audit data 156, in some embodiments, can include a list of the comparison of entity property data 154 against applicable assignment data 158 generated by audit assignments operation 138. In some embodiments, the audit data 156 can map each audit record to a unique audit record key, which can be used to refer to the audit data 156 in other data structures. As non-limiting examples, audit data 156 can store the comparison of assignment data 158, entity property data 154 and team data 162 or the comparison of assignment data 158, entity property data 154 and association data 164. In some embodiments, the unique audit key can be a combination of multiple keys, such as, for a non-limiting example, team data unique key and property data unique key. Some embodiments further associate audit data records with a category, such as by including a category column not illustrated in the audit data 156. The audit data categories can include, as non-limiting examples, association, sport, age group, league, date, facility, and other applicable categories. In some embodiments, multiple audit data 156 can be stored for a single participant and property data combination that may use a category or other audit data detail to be unique, such as, for a non-limiting example, for a weekly property 50, the week can be used to make multiple audit data records unique.

The audit data 156, in some embodiments, can include details about the audit record, such as participant 22, property 50, participant value, concern, or other details. Audit data details contain additional information that can, in some embodiments, be configured or programmed into application program 112 for processing within data store 104, processing within application server 106, or processing within web server 110. Other embodiments can include more or fewer audit data details. A participant value of the audit data 156 can, in some embodiments, be, as non-limiting examples, a decimal, an integer, a real number, a string, or other appropriate data type. The participant value can be an assessment of assignment data 158 for applicable entity property data 154. By way of non-limiting example, participant 22 value is the total number of solo practice assignment 48 in assignment data 158 for participant 22. In some embodiments, the participant value of the audit data 156 can be a numerical value that can be compared against other available numerical values. In some other embodiments, the participant value of the audit data 156 can be a true or false value. In some embodiments, an concern detail of the audit data 156 can, as a non-limiting example, indicate the relative severity of the participant value of the audit data 156 for team data and entity property data combination, such as, for non-limiting example, for a solo practice property 50, when participant 22 value is less than entity property data 154 setting detail, concern is high, and when participant 22 value is greater than entity property data 154 setting detail, concern is ignore. In some embodiments, the concern detail of the audit data 156 can indicate the relative severity of participant value for associated association data and property data combination. In some alternative embodiments, audit data detail will not be maintained in data store 104 or audit data 156, where, for non-limiting example, audit data 156 is generated upon request from user interface 116.

FIG. 11 is a flowchart illustrating an example method 175 of operating the schedule management system 102. The schedule management system 102 executes the scheduling process 122 to perform the methodology 120 on at least one of the application server 106, the web server 110, and the data store 104. In at least some embodiments, the method 175 includes a define properties operation 124, a generate events decision operation 126, a generate events operation 128, an obtain events operation 130, a generate combinations operation 132, a score combinations operation 134, an assign events operation 136, an audit assignments operation 138, a recommend adjustments operation 140, and an adjust schedule operation 142. The method 175 can include a plurality of operations that, when executed by at least one of the application server 106, the web server 110, and the data store 104, may perform one or more processes in the schedule management system 102. In some embodiments, the method 175 may contain more or fewer operations.

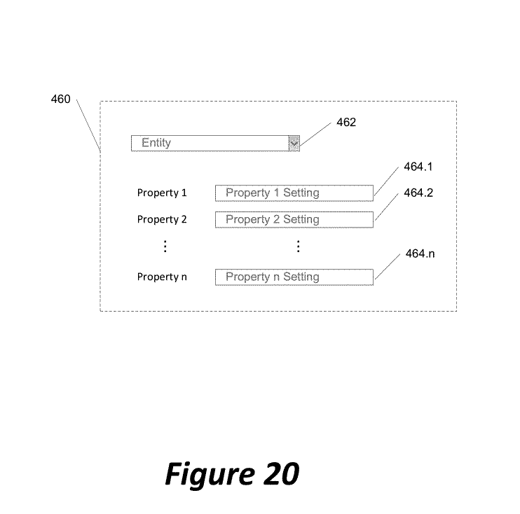

In the define properties operation 124, the schedule management system 102 operates to gather the details of property 50 for, as non-limiting examples, facility 10, association 12, team 14, and/or other entities 56. The facility property captured can include, as non-limiting examples, available times, available dates, time between events, distance, rate, and other applicable properties. The association property captured can include, as non-limiting examples, the number of practices, the number of games, times available, dates available, days of the week available, length of event, event sharing, and other applicable properties. In at least some embodiments, the user interface 116 (e.g., FIG. 20) is used to capture the property 50 and/or store it in the data store 104. In other embodiments, the schedule management system 102 can use other input methods to capture the property 50 and/or store in the data store 104.

In some embodiments, the define properties operation 124 can derive property 50 using other information maintained in data store 104. The derived property settings can be determined using one or more other properties 50, such as, for non-limiting examples, time of day allowed, days of week allowed, and other derived properties. By way of non-limiting example, the entity property data 154 can be defined as Monday allowed, and the derived entity property data 154 can be defined as weekday allowed that is true or false based on the value of Monday allowed entity property data 154 for entity 56. The derived property 50 can be stored by the schedule management system 102 in the data store 104. In some embodiments, more or fewer derived properties 50 may be used.

In some embodiments, the define properties operation 124 can calculate property 50 using other information maintained in data store 104. The calculated property 50 can include, as non-limiting examples, weekly allocations, allocations for late or early event, or other calculated properties. For a non-limiting example, the weekly allocations entity property data can be defined that uses a mathematical formula to calculate property using total allocation entity property and total number of weeks entity property. The calculated property 50 can, in some embodiments, be stored by the schedule management system 102 in data store 104 for further processes by the schedule management system 102. In some embodiments, more or fewer calculated properties 50 may be used.

With continued reference to FIG. 11, in the generate events decision operation 126, the schedule management system 102 determines whether it should either generate or obtain events to generate the schedule data 114 containing an athletic schedule 20. In at least some embodiments, the generate events decision operation 126 uses information available, as non-limiting examples, in the data store 104 or from the user interface 116. The schedule management system 102 uses the information to determine whether athletic schedule 20 should use the generated event 46, the obtained event 46, or both of the generated and obtained events 46. The information used can include, as non-limiting examples, the type of athletic schedule 20, entity property data 154, other information from data store 104, information derived from other methods in the schedule management system 102, information obtained from the user interface 116, or other sources of information. In other alternative embodiments, the generate events decision operation 126 is not performed where the schedule management system 102 performs both of the generate events operation 128 and the obtain events operation 130 to generate the schedule data 114.

In the generate events operation 128, the schedule management system 102 uses a combination of facility data 170, association data 164, entity property data 154, and other data to generate possible events 46 that may be assigned to the participant 22. The generate events operation 128 can be used for generating the schedule data 114 including facility schedule 16 and/or association schedule 18. The generate events operation 128 can provide possible events 46 that may be assigned to participant 22, such as association 12 or team 14. The schedule management system 102 can maintain these generated events 46 for further operations to generate the schedule data 114 containing an athletic schedule 20. In some other embodiments, the generate events operation 128 uses more, less, or no data from facility data 170, association data 164, or entity property data 154. In some other embodiments, the generate events operation 128 does not store generated event 46 in data store 104 as they can be passed directly to the next operation.

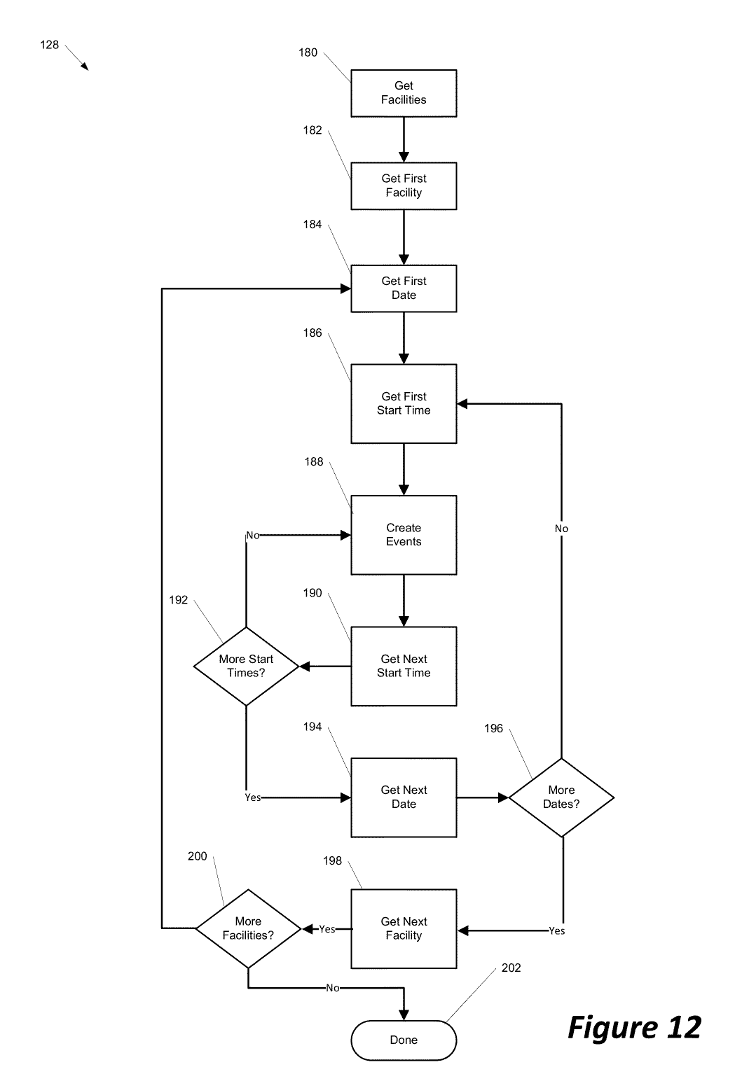

FIG. 12 illustrates an exemplary method for performing the generate events operation 128. The generate events operation 128 includes a plurality of steps that can be executed to generate possible event 46. In some embodiments, the generate events operation 128 includes get facilities step 180, get first facility step 182, get first date step 184, get first start time step 186, create event step 188, get next start time step 190, more start times decision 192, get next date step 194, more dates decision 196, get next facility step 198, and more facilities decision 200. In some embodiments, the generate events operation 128 may process facility, date, and time in a different order, such as for non-limiting examples: date, then facility, then start time; or date, then start time, then facility; or other possible order. In some embodiments, the generate events operation 128 may use end times instead of start times. In some embodiments, the generate events operation 128 may contain more or fewer steps. In some embodiments, the generate events operation 128 can share information between steps by, as non-limiting examples, passing information from one step to another, passing keys from one step to another, storing information in data store 104 for retrieval by the next step, or other operation for passing information between steps.

The get facilities step 180 can be executed to retrieve applicable facility data 170. The get facilities step 180 can, in some embodiments, retrieve facility data 170 for facility 10 included in athletic schedule 20 being generated. The get facilities step 180 can, in some embodiments, retrieve facility data 170 for facility 10 used by association 12 included in association schedule 18 being generated. In some embodiments, the get facilities step 180 can retrieve facility data 170 for zero, one, or more facility 10. The get facilities step 180 can retrieve information from data store 104, user interface 116, or other information source.

The get first facility step 182 can be executed to initiate the process of looping through available facility data 170 retrieved in get facilities step 180. Get first facility step 182 can determine the first facility 10 to process from facility data 170 obtained in get facilities step 180. In some embodiments, get facilities step 180 can pass a facility data 170 unique key to get first facility step 182, and get first facility step 182 can retrieve additional facility data 170. Get first facility step 182 can determine first facility 10, for non-limiting examples, by ordering facility data 170 by a unique key, by ordering facility data 170 by another data detail, by selecting facility 10 randomly, or by other selection criteria. In some embodiments, get facilities step 180 or get first facility step 182 may not executed, such as there is only one facility 10, facility 10 is not needed for generating event 46, or other applicable reason for not using facility data 170 in generate events operation 128.

Get first date step 184 can be executed to get the starting date for looping through available dates for athletic schedule 20. Get first date step 184 can retrieve possible dates from facility data 170, entity property data 154, user interface 116, or other available data source. For a non-limiting example, get first date step 184 can use association data 164 start date detail or facility data 170 start date detail. Get first date step 184 can determine the first date, for non-limiting examples, by selecting the earliest available date, by selecting the latest available date, by selecting a random available date, or by other selection criteria. In some embodiments, get first date step 184 may not executed, such as, for non-limiting examples, there is only one date or all dates are processed in a single step. In some embodiments, available dates can vary by, as non-limiting examples, facility 10, association 12, team 14, or other available elements.

Get first start time step 186 can be executed to get the starting time for looping through available times for athletic schedule 20. Get first start time step 186 can retrieve possible times from facility data 170, association data 164, entity property data 154, user interface 116, or other available data source. For a non-limiting example, get first start time step 186 can use facility data 170 start time detail. Get first start time step 186 can determine the first time, for non-limiting examples, by selecting the earliest available time, by selecting the latest available time, by selecting a random available time, or by other selection criteria. In some embodiments, get first start time step 186 may not be executed, such as, for non-limiting examples, there is only one start time, all start times are processed in a single step, available start times are stored in data store 104, or all start times from midnight to midnight are possible. In some embodiments, available times can vary by facility 10, by association 12, by team 14, or by other available elements.

Create event step 188 can be executed to generate event 46 comprising facility 10 identified in get first facility step 182 or get next facility step 198; date identified in get first date step 184 or get next date step 194; and start time identified in get first start time step 186 or get next start time step 190. Event 46 generated, in create event step 188, can be stored within data store 104 for use by other steps in methodology 120. In some embodiments, create event step 188 may include a duration 42 for event 46 that indicates how long facility 10 can be used by participant 22. In some embodiments, event 46 generated can be made available to other steps in methodology 120 without storing in data store 104. In some embodiments, create event step 188 may create one or more event 46 using the information provided, such as, for non-limiting example, event 46 created for multiple available duration 42.

Get next start time step 190 can be executed to determine another possible start time to use for create event step 188. Get next start time step 190 can use information from data store 104 to determine the next possible start time, such as, for non-limiting example, facility data 170 time between events detail. In some embodiments, get next start time step 190 may determine that an earlier start time should be processed next. In some embodiments, get next start time step 190 may determine that a later start time should be processed next. In some embodiments, get next start time step 190 may use property data 152 or entity property data 154 to determine the next start time to be processed, such as, for non-limiting examples, entity property 54 indicates the start times should be processed from latest to earliest, or entity property 54 indicates the start times should be processed from earliest to latest. In some embodiments, get next start time step 190 may not be executed, such as, for non-limiting examples, there is only one possible start time or start times can be processed in a single execution of create event step 188.

More start times decision 192 can be executed to determine the next step to be processed depending on the output of get next start time step 190. More start times decision 192 can use information from data store 104 to determine if the next start time is included in the possible start times, such as, for non-limiting example, facility data 170 earliest start time detail and facility data 170 latest start time facility detail. If the next start time is possible, more start times decision 192 can decide that the create event step 188 should be executed next. If the next start time is not possible for facility 10, more start times decision 192 can decide that get next date step 194 should be executed next. In some embodiments, more start times decision 192 can determine that get next start time step 190 should be executed to determine another available start time not illustrated. In some embodiments, more start times decision 192 may not be executed, such as, for non-limiting example, get next start time step 190 makes the decision on the next step to be processed.

Get next date step 194 can be executed to determine another possible date to use for create event step 188. In some embodiments, get next date step 194 may determine that an earlier date should be processed next. In some embodiments, get next date step 194 may determine that a later date can be processed next. In some embodiments, get next date step 194 can use property data 152 or entity property data 154 to determine the next date to be processed, such as, for non-limiting examples, entity property 54 indicates a random date should be used, or entity property 54 indicates the next calendar date should be used, or entity property 54 indicates the previous calendar date should be used. In some embodiments, get next date step 194 may not be executed, such as, for non-limiting examples, there is only one possible date or dates can be processed in a single step.

More dates decision 196 can be executed to determine the next step to be processed depending on the output of get next date step 194. More dates decision 196 can use information from data store 104 to determine whether the next date from get next date step 194 should have event 46 created, such as, for non-limiting examples, the facility data 170 start date detail and facility data 170 end date detail, or the association data 164 start date detail and association data 164 end date detail. If the next date is determined to be possible, more dates decision 196 can decide that get first start time step 186 should be executed next. If the next date is determined to be not possible, more dates decision 196 can decide that get next facility 198 should be executed next. In some embodiments, more dates decision 196 can determine that get next date step 194 should be executed to determine another available date not illustrated. In some embodiments, more dates decision 196 may not be executed, such as, for non-limiting example, only one date is available, all dates can be processed in a single step, or more dates decision 196 is processed during get next date step 194.

Get next facility step 198 can be executed to determine another possible facility 10 to use for create event step 188. Get next facility step 198 can determine next facility 10, for non-limiting examples, by selecting next facility 10 using a unique key, by selecting next facility 10 using another detail, by selecting next facility 10 randomly, or by other selection criteria. Get next facility step 198 can obtain next facility 10 from, as non-limiting examples, information obtained in get facilities step 180, facility data 170 in data store 104, or other data sources. In some embodiments, get next facility step 198 may not be executed, such as, for non-limiting examples, there is only one available facility 10 or possible facility 10 can be processed in a single execution of create event step 188. In some embodiments, get next facility step 198 may retrieve only next facility 10 unique key for processing by the next step.

More facilities decision 200 can be executed to determine the next step to be processed depending on the output of get next facility step 198. If get next facility step 198 identifies that there is another available facility 10, more facilities decision 200 can decide that get first date step 184 should be executed next. If get next facility step 198 cannot identify another available facility 10, more facilities decision 200 can decide that generate events operation 128 is done 202. In some embodiments, more facilities decision 200 may not be executed, such as, for non-limiting examples, there is only one available facility 10 or available facility 10 can be processed in a single execution of create event step 188. In some embodiments, more facilities decision 200 can be combined with get next facility step 198 into a single processing step.

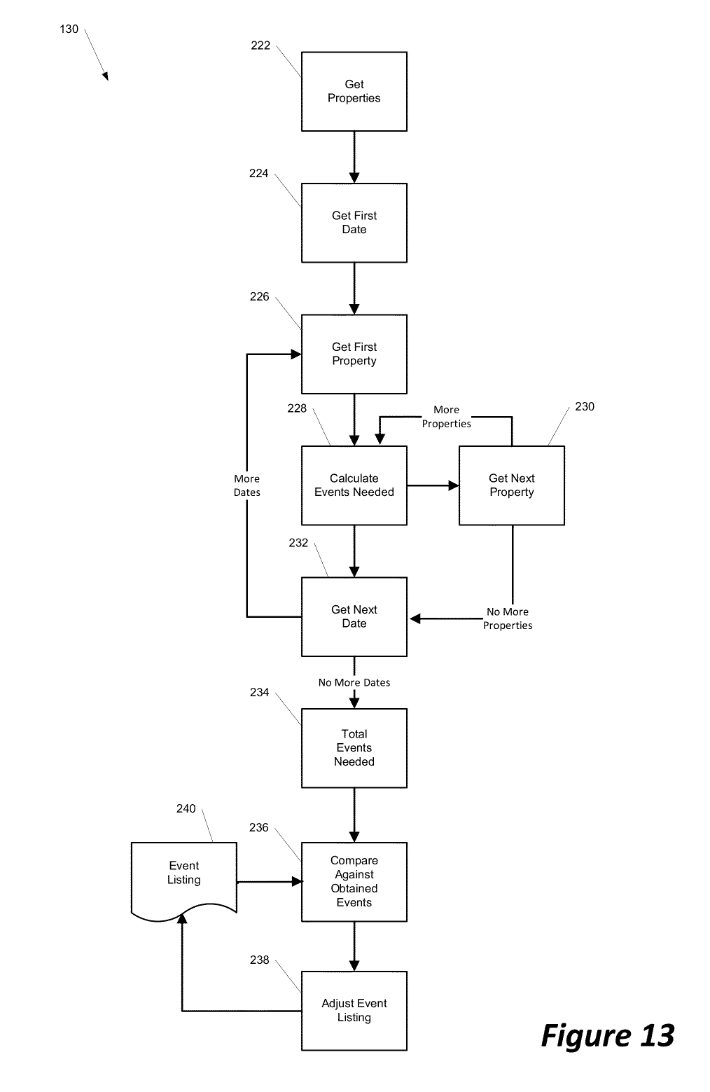

Turning again to FIG. 11, in the obtain events operation 130, the schedule management system 102 processes entity property data 154 to generate recommendations of dates and counts of event 46 that should be obtained from facility 10 for athletic schedule 20. The obtain events operation 130 is described in more detail with reference to FIG. 13.

FIG. 13 illustrates an exemplary method of performing the obtain events operation 130. In at least some embodiments, the obtain events operation 130 includes a plurality of steps, such as get properties step 222, get first date step 224, get first property step 226, calculate events needed step 228, get next property step 230, get next date step 232, get total events needed step 234, input of event listing 240, compare against obtained events step 236, and adjust event listing step 238. In some embodiments, entity property data 154 and dates may be processed in a different order, such as, entity property data 154 first and dates second. In some embodiments, entity property data 154 can be processed in a single step. In some embodiments, dates can be processed in a single step. In some embodiments, participant 22 may be processed individually through obtain events operation 130, so in these embodiments, another loop may be used for participant 22. In some embodiments, obtain events operation 130 may contain more or fewer steps. In some embodiments, obtain events operation 130 can share information between steps by, as non-limiting examples, passing information from one step to another, passing keys from one step to another, storing information in data store 104 for retrieval by the next step, or other operation for passing information between steps.

In some embodiments, the input event listing 240 can be a listing of event 46 that may be used in the generation of athletic schedule 20. Event listing 240 may contain facility 10, start date/time 40, duration 42, participant 22, or other applicable data. For non-limiting examples, event listing 240 may come from facility 10 as input to association schedule 18, from association 12 as input to facility schedule 16, from team 14 as input to association schedule 18, from data store 104 for previously generated athletic schedule 20, from data store 104 for athletic schedule 20 being generated, or from other available sources. Event listing 240 may be received, as non-limiting examples, directly from data store 104 for entity 56 that uses system 100, or imported into data store 104 for organization 24 that use a different system. In some embodiments, after obtaining more event 46 from input event listing 240, scheduling process 122 can, in some embodiments, be executed to update the recommended dates and counts of event 46 that should be obtained. In some embodiments, obtain events operation 130 may store event 46 obtained from event listing 240 in data store 104 for use in generating athletic schedule 20.

Get properties step 222 can be executed to retrieve applicable entity property data 154 for entity 56 associated with athletic schedule 20 being generated, such as, for non-limiting examples association 12, team 14, facility 10, or other entity 56. Get properties step 222 may retrieve one or more applicable entity property data 154 from data store 104, including, as non-limiting examples, start date entity property 54, end date entity property 54, applicable week days entity property 54, entity property 54 for dates that should not be assigned, entity property 54 for dates that must be assigned, entity property 54 for facility 10 that should not be assigned, entity property 54 for facility 10 that must be assigned, or other applicable entity property 54. In some embodiments, get properties step 222 can obtain one or more entity property 54 from user interface 116. In some embodiments, get properties step 222 can retrieve applicable property data 152 for processing during obtain events operation 130.

Get first date step 224 can be executed to get the starting date for looping through available dates for athletic schedule 20 being generated. Get first date step 224 can retrieve possible dates from facility data 170, entity property data 154, user interface 116, or other available data sources. For a non-limiting example, get first date step 224 can use association data 164 start date detail or facility data 170 start date detail. Get first date step 224 can determine the first date, for non-limiting examples, by selecting the earliest available date, by selecting the latest available date, by selecting a random available date, or by other selection criteria. In some embodiments, get first date step 224 may not executed, such as, for non-limiting examples, there is only one date or all dates can be processed in a single step. In some embodiments, available dates can vary by facility 10, by association 12, by team 14, or by other available elements.

Get first property step 226 can be executed to get the first entity property 54 to be processed that was retrieved in get properties step 222. Get first property step 226 may receive entity property data 154 directly from get properties step 222. Get first property step 226, in some other embodiments, may retrieve property data 152, entity property data 154, team data 162, association data 164, or other information from data store 104 for processing during obtain events operation 130. In some embodiments, get first property step 226 may not be executed if, as non-limiting examples, entity property 54 retrieved from get properties step 222 can be processed in a single step, or there is only one entity property 54 received from get properties step 222.

Calculate events needed step 228 can, in some embodiments, be executed to process the input date from get first date step 224 or get next date step 232 and entity property 54 retrieved in get first property step 226 or get next property step 230 to determine if event 46 may be needed for participant 22 on this date. As non-limiting examples, calculate events needed step 228 may determine that event 46 is not needed on date because a facility 10 start date entity property 54 is after the date being processed; or that event 46 is needed because the date being processed is between association 12 start date entity property 54 and association 12 end date entity property 54; or that multiple event 46 are needed because a team 14 daily count entity property 54 is greater than one. In some embodiments, calculate events needed step 228 may determine that a partial event 46 is needed on the date being processed, such as, for non-limiting examples, a weekly event count entity property 54 indicates that participant 22 should have no more than one event 46 in the week surrounding the date being processed; or that a sharing entity property 54 indicates that participant 22 can share event 46 with another participant 22 thus not needing a whole event 46. Calculate events needed step 228 output can be, as non-limiting examples, a decimal, integer, or other numeric value of event 46 needed. Calculate events needed step 228 may store the output value in data store 104 for use by other operations not illustrated. Calculate events needed step 228 may, in some embodiments, process all information in a single execution, rather than looping through dates and property 50, entity property 54 or other information.

Get next property step 230 can be executed to determine the next entity property 54 to process in calculate events needed step 228. Get next property step 230 may use information obtained in get properties step 222, information from user interface 116, information from data store 104, or other information to determine the next entity property 54 to be processed. Get next property step 230 may, in some embodiments, select the next sequential entity property 54 obtained from get properties step 222. Get next property step 230 may, in some embodiments, use information from user interface 116 to determine the next entity property 54 to process, such as, for a non-limiting example, user interface 116 indicates to process date entity property 54 before processing other entity property 54. In some embodiments, get next property step 230 may select the next entity property 54 randomly. Get next property step 230 may decide to process the next date, if, as non-limiting examples, entity property data 154 has been processed or only one entity property 54 was obtained in get properties step 222. Get next property step 230 may not be executed, if, as non-limiting example, only one entity property 54 was retrieved in get properties step 222.

Get next date step 232 can be executed to determine another possible date to use for calculate events needed step 228. In some embodiments, get next date step 232 may determine that an earlier date should be processed next. In some embodiments, get next date step 232 may determine that a later date should be processed next. In some embodiments, get next date step 232 can use property data 152 or entity property data 154 to determine the next date to be processed, such as, for non-limiting example, a property 50 indicates a random date should be used, or an entity property 54 indicates the next calendar date should be used, or an entity property 54 indicates the previous calendar date should be used. In some embodiments, get next date step 232 may not be executed, such as, for non-limiting examples, there is only one possible date or available dates can be processed in a single execution of calculate events needed step 228.

Total events needed step 234 can be executed to summarize event 46 needed information determined in calculate events needed step 228 to determine the total number of event 46 needed for each of the applicable dates. Total events needed step 234 may, in some embodiments, retrieve event 46 needed information determined in calculate events needed step 228 from data store 104. Total events needed step 234 may, in some embodiments, store the total event 46 needed value in data store 104 not illustrated. Total events needed step 234 may, in some embodiments, summarize event 46 needed by participant 22, by facility 10, by date, or by other available criteria. In some embodiments, total events needed step 234 may not be executed, such as, for non-limiting examples, event 46 needed summary is determined in calculate events needed step 228, only one event 46 is needed, or all event 46 needed information is processed in a single step.

Compare against obtained events step 236 can be executed to calculate the variance between the information from total events needed step 234 and the information obtained from event listing 240. Compare against obtained events step 236 can count event 46 contained on event listing 240 to determine the actual event 46 previously obtained. Compare against obtained events step 236 can use total events needed step 234 value and actual event 46 obtained value to calculate a variance indicating whether more or fewer event 46 are needed on a particular date. Compare against obtained events step 236 may, in some embodiments, calculate the variance by participant 22, by facility 10, by date, or by other available criteria available. In some embodiments, compare against obtained events step 236 may store the variance in data store 104 not illustrated. In some embodiments, compare against obtained events step 236 may not be executed, such as, for non-limiting examples, the variance is determined in total events needed step 234.

Adjust event listing step 238 can be executed by system 100 or by user interface 116. Adjust event listing step 238 can use the variances determined in compare against obtained events step 236 to determine the dates that event 46 should be added, removed, or remain unchanged. In some embodiments, adjust event listing step 238 can be executed by system 100 using available event data 166 for applicable facility 10. If the variance indicates that additional event 46 are needed, system 100 may use event data 166 to reserve additional event 46 from facility 10 using system 100 to be included in event listing 240. If the variance indicates that there are too many event 46 in event listing 240, then system 100 may return event 46 to facility 10 using system 100. In some embodiments, system 100 may access external systems to reserve or return event 46 based on the variance calculated not illustrated. In some embodiments, adjust event listing step 238 may not be executed, such as, for non-limiting example, event listing 240 is adjusted in compare against obtained events step 236.

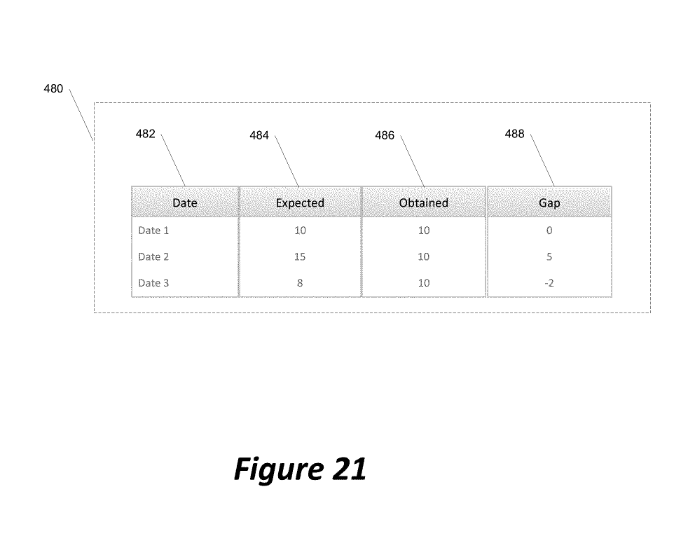

In some embodiments, the adjust event listing step 238 can be executed by user interface 116, which is illustrated in more detail with reference to FIG. 21.

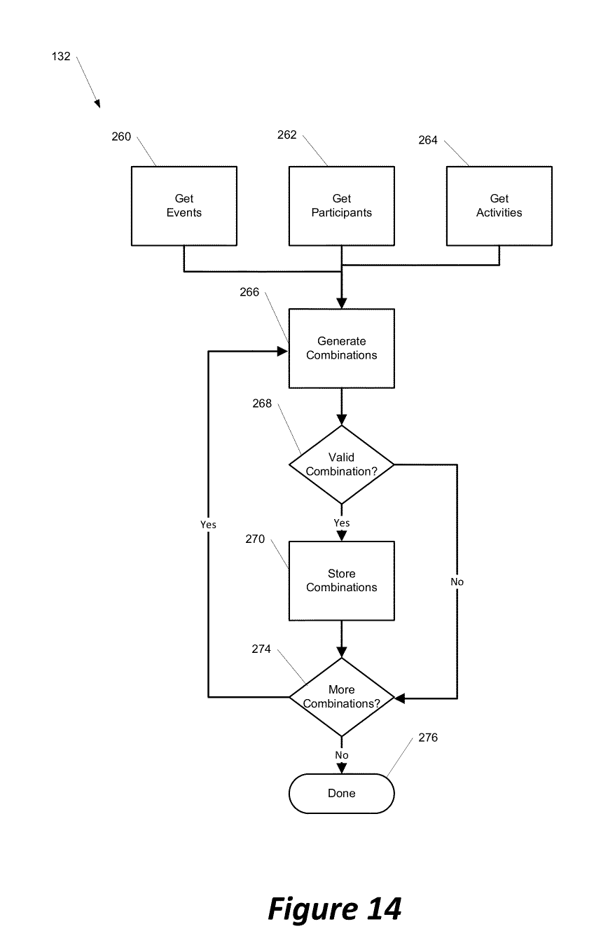

Turning again to FIG. 11, in the generate combinations operation 132, the schedule management system 102 determines the appropriate assignment combination 52 that can be processed. An example of the generate combinations operation 132 is described in more detail with reference to FIG. 14.

FIG. 14 illustrates an exemplary method of performing the generate combinations operation 132. In at least some embodiments, the generate combinations operation 132 includes a plurality of steps such as get events step 260, get participants step 262, get activities step 264, generate combinations step 266, valid combination decision 268, store combination step 270, and more combinations decision 274. The generate combinations operation 132 can, in some embodiments, be responsible for creating possible assignment combination 52 of participant 22, event 46 and activity 44 that is processed by the schedule management system 102. In some embodiments, the system 102 may store assignment combination 52 in data store 104. In some embodiments, generate combinations operation 132 may contain more or fewer steps. In some embodiments, generate combinations operation 132 can share information between steps by, as non-limiting examples, passing information from one step to another, passing keys from one step to another, storing information in data store 104 for retrieval by the next step, or other operation for passing information between steps.

Get events step 260 can be executed to retrieve applicable event data 166 from data store 104 for use in generate combinations operation 132. Event 46 may include event 46 assigned to participant 22 or event 46 that have not been assigned to participant 22. In some embodiments, get events step 260 may use information from data store 104 to limit the types of event 46 retrieved, such as, for non-limiting examples, association data 164, facility data 170, or other criteria information. The data retrieved to limit event 46 can be, as non-limiting examples, a unique facility 10 key, a time of day, a day of the week, a specific month, or other available criteria. In some embodiments, get events step 260 may not be executed, such as, for non-limiting example, get events step 260, get participants step 262, get activities step 264, and generate combinations step 266 are executed as a single step.

Get participants step 262 can be executed to retrieve appropriate team data 162, association data 164, or other participant 22 data from data store 104 for use in generate combinations operation 132. Participant 22 can include, as non-limiting examples, association 12, team 14, or other applicable participant 22 for athletic schedule 20. In some embodiments, get participants step 262 may use information from data store 104 to limit participant 22 retrieved, such as, for non-limiting examples, team data 162, association data 164, or other criteria information. The information retrieved to limit participant 22 considered in get participants step 262 can be, as non-limiting examples, a team data 162 automated assignment flag detail not illustrated indicating participant 22 should be included in get participants step 262, participant 22 data participant type detail not illustrated, association 12 unique key, or other available criteria. In some embodiments, get participants step 262 may not be executed, such as, for non-limiting example, get events step 260, get participants step 262, get activities step 264, and generate combinations step 266 are executed as a single step.

Get activities step 264 can be executed to retrieve appropriate activity data 168 from data store 104. Get activities step 264 can retrieve information from, as non-limiting examples, entity property data 154, user interface 116, activity data 168, or other source of data. Entity property data 154 may include property 50 that indicate whether activity 44 can be scheduled for participant 22, such as, for non-limiting examples, a solo practice allowed property 50, a game allowed property 50, a shared practice allowed property 50, a tournament allowed property 50, an away game allowed property 50, or other property 50. User interface 116 may provide activity 44 to be scheduled using a control that allows the selection of one or more activity data 168 to be provided as input to generate combinations operation 132. Data store 104 may have activity data 168 stored that can be accessed by generate combinations operation 132 as an input not illustrated. In some embodiments, get activities step 264 may use information from data store 104 to limit the activity data 168 retrieved, such as, for a non-limiting example, activity data 168 automated assignment flag detail indicating activity 44 should be included in get activities step 264. In some embodiments, get activities step 264 may not be executed, such as, for non-limiting example, get events step 260, get participants step 262, get activities step 264, and generate combinations step 266 are executed as a single step.

Generate combinations step 266 can be executed to use information obtained in get events step 260, get participants step 262, and get activities step 264 to determine possible assignment combination 52 that should be generated by generate combinations operation 132. Generate combinations step 266 can, in some embodiments, loop through event 46, participant 22, and activity 44 retrieved in get events step 260, get participants step 262, and get activities step 264 to generate assignment combination 52 that may be considered for assignment 48. In some embodiments, generate combinations step 266 may include other details that create additional assignment combination 52, such as, for non-limiting examples, a duration 42, another participant 22 for shared event 46, or other detail. In some embodiments, generate combinations step 266 can be executed as a single step for assignment combination 52, as a loop through event 46 with participant 22 and activity 44 processed for each event 46, as a loop through participant 22 with event 46 and activity 44 processed for each participant 22, or other operation of determining assignment combination 52. In some embodiments, generate combinations step 266 can loop through duration 42 information to create additional assignment combination 52. In some embodiments, generate combinations step 266 may not be executed, such as, for non-limiting example, get events step 260, get participants step 262, get activities step 264, and generate combinations step 266 are executed as a single step.

Valid combination decision 268 can be executed to eliminate assignment combination 52 from further consideration based upon entity property data 154, or other available information. Valid combinations decision 268 can use information to determine if assignment combination 52 is valid for consideration for assignment 48, such as, for non-limiting example, entity property data 154 indicates that participant 22 can only use Saturday event 46 and assignment combination 52 can include a weekday event 46, entity property data 154 indicates that participant 22 does not play games and assignment combination 52 has a game activity 44, or other considerations based on available information. Valid combination decision 268 can, in some embodiments, pass valid assignment combination 52 to store combination step 270. In some embodiments, valid combination decision 268 can loop through available details for each assignment combination 52. In some embodiments, valid combination decision 268 can loop through assignment combination 52 and process details once for each assignment combination 52. In some embodiments, valid combination decision 268 can process details against assignment combination 52 in a single step. In some embodiments, valid combination decision 268 can delete invalid assignment combination 52 from the available assignment combination 52 when determined invalid. In some embodiments, valid combination decision 268 can determine that store combination step 270 can be skipped for invalid assignment combination 52. In some embodiments, valid combination decision 268 may not be executed, such as, for non-limiting example, generate combinations step 266 make the validity decision.

Store combination step 270 can be executed to store valid assignment combination 52 for further processing. In some embodiments, assignment combination 52 can be stored in data store 104 not illustrated. In some embodiments, system 100 can maintain assignment combination 52 for further processing.

More combinations decision 274 can be executed to determine if additional processing is required for available assignment combination 52. More combinations decision 274 can decide on additional processing based upon the looping criteria executed in generate combinations step 266, including, as non-limiting examples, event 46, participant 22, activity 44, duration 42, or other available criteria. In some embodiments, more combinations decision 274 may pass control back to generate combination step 266, if additional processing is determined necessary. More combinations decision 274 may decide that generate combinations 132 is done 276 if additional processing is determined unnecessary.

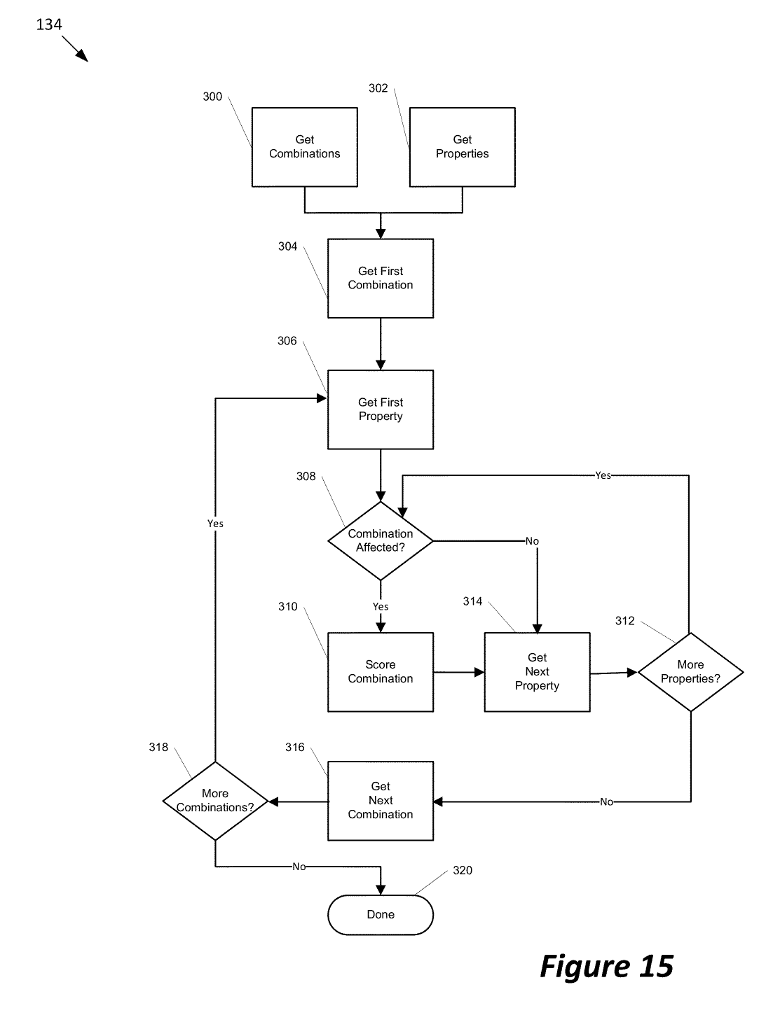

Turning again to FIG. 11, in the score combinations operation 134, the schedule management system 102 prioritizes assignment combination 52 for assignment 48. An example of the score combinations operation 134 is described in more detail with reference to FIG. 15.

FIG. 15 illustrates an exemplary method of performing the score combinations operation 134. In at least some embodiments, the score combinations operation 134 includes a plurality of steps, such as get combinations step 300, get properties step 302, get first combination step 304, get first property step 306, combination affected decision 308, score combination step 310, more properties decision 312, get next property step 314, more combinations decision 318, and get next combination step 316. The schedule management system 102 can, in some embodiments, use selected audit data 156 participant 22 value detail and entity property data 154 setting detail, for appropriate property data 152, including derived property data 152 and calculated property data 152, to generate a score which may be summarized with other property 50 scores to generate assignment combination 52 score. Assignment combination 52 scores include, as non-limiting examples, decimals, integers, audit data 156 participant 22 value detail, entity property data 154 setting detail, calculations based on audit data 156 participant 22 value detail and entity property data 154 setting detail, or other appropriate scores. Scores generated by the schedule management system 102 can be stored within data store 104 to be used when generating athletic schedule 20. In some embodiments, property 50 and assignment combination 52 may be processed in a different order, such as, property 50 first and assignment combination 52 second. In some embodiments, assignment combination 52 can be processed in a single step. In some embodiments, property 50 can be processed in a single step. In some embodiments, participant 22 may be processed one at a time through score combinations operation 134, which may add another loop to the illustrated flow. In some embodiments, score combinations operation 134 may contain more or fewer steps. In some embodiments, score combinations operation 134 can share information between steps by, as non-limiting examples, passing information from one step to another, passing keys from one step to another, storing information in data store 104 for retrieval by the next step, or other operation for passing information between steps.

Get combinations step 300 can be executed to retrieve assignment combination 52 determined in generate combinations operation 132. In some embodiments, assignment combination 52 can be retrieved directly from generate combinations operation 132. In some embodiments, assignment combination 52 can be retrieved from data store 104. In some embodiments, get combinations step 300 can limit assignment combination 52 processed by available criteria, such as, for non-limiting examples, event 46, participant 22, activity 42, association 12, duration 42, or other available criteria. In some embodiments, get combinations step 300 may not be executed, such as, for a non-limiting example, get combinations step 300 and get properties step 302 are executed as a single step.

Get properties step 302 can be executed to retrieve applicable property 50 to be included in scoring assignment combination 52. Get properties step 302 may retrieve one or more applicable property 50 from property data 152 in data store 104, including, as non-limiting examples, activity 44 priority property 50, event 46 count property 50, required event 46 property 50, facility 10 priority property 50, association 12 priority property 50, or other applicable property 50 that can be used to score assignment combination 52. In some embodiments, get properties step 302 can obtain one or more property 50 from user interface 116, such as, for non-limiting examples, activity 44 priority property 50, association 12 priority property 50, or other available information. In some embodiments, get properties step 302 may not be executed, such as, for a non-limiting example, get combinations step 300 and get properties step 302 are executed as a single step.

Get first combination step 304 can be executed to get the first assignment combination 52 to be processed from get combinations step 300. Get first combination step 304 may, in some embodiments, receive assignment combination 52 information directly from get combinations step 300. Get first combination step 304 may, in some embodiments, retrieve assignment combination 52 information from data store 104. In some embodiments, get first combination step 304 may not be executed, if, as non-limiting examples, assignment combination 52 retrieved in get combinations step 300 can be processed in a single step, or there is only one assignment combination 52 received from get combinations step 300.

Get first property step 306 can be executed to get the first property 50 to be processed from get properties step 302. Get first property step 306 may, in some embodiments, receive property 50 information directly from get properties step 302. Get first property step 306, in some other embodiments, may retrieve property data 152 from data store 104 for processing. In some embodiments, get first property step 306 may not be executed if, as non-limiting examples, property 50 retrieved from get properties step 302 can be processed in a single step, or there is only one property 50 received from get properties step 302.

Combination affected decision 308 can be executed to determine if property 50 identified in get first property step 306 or get next property step 314 affects assignment combination 52 identified in get first combination step 304 or get next combination step 316, such as, for non-limiting examples, property 50 is for a specific date, property 50 is for a specific activity 44, property 50 is for a specific duration 42, property 50 is for a specific month, or other applicable criteria that may or may not match assignment combination 52. Combination affected decision 308 can decide, if property 50 affects assignment combination 52, that score combination step 310 should be executed. Combination affected decision 308 can decide, if property 50 does not affect assignment combination 52, that more properties decision 312 should be executed.

Score combination step 310 can be executed to calculate a score or other priority for assignment combination 52 using assignment combination 52 information, property data 152, event data 166, team data 162, activity data 168, or other applicable information. Score combination step 310 can, in some embodiments, adjust audit data 156 participant 22 value detail based on how assignment combination 52 would affect audit data 156 participant 22 value detail if it were to be assigned, such as, for a non-limiting example, a solo practice event 46 count audit data 156 participant 22 value has one added to the participant 22 value to account for the adding of a solo practice. The adjusted audit data 156 participant 22 value detail can be compared against entity property data 154 setting detail to calculate the appropriate property 50 score for assignment combination 52. The score can be, as non-limiting examples, an integer value, a decimal value, a positive number, a negative number, a calculation using audit data 156 participant 22 value detail and entity property data 154 setting detail, audit data 156 participant 22 value detail, entity property data 154 setting detail, a calculation using audit data 156 participant 22 value detail, a calculation using entity property data 154 setting detail, zero, a random integer, a random decimal, or other applicable operation for generating a score. Score combination step 310 can, in some embodiments, assign a score because assignment combination 52 exists. Score combination step 310 can, in some embodiments, update data store 104 with the score that was calculated. Score combination step 310 can, in some embodiments, add the score for property 50 being processed to a total score for assignment combination 52. Score combination step 310 can, in some embodiments, maintain property 50 scores separate from other property 50 scores, and can summarize applicable property 50 scores in another step not illustrated.

Get next property step 314 can be executed to determine the next property 50 to process in score combination step 310. Get next property step 314 may use information obtained in get properties step 302, information from user interface 116, other information from data store 104, or other information to determine the next property 50 to be processed. Get next property step 314 may, in some embodiments, select the next sequential property 50 obtained from get properties step 302. Get next property step 314 may, in some embodiments, use information from user interface 116 to determine the next property 50, such as, for a non-limiting example, user interface 116 indicates to process date property 50 before processing other property 50. In some embodiments, get next property step 314 may select the next property 50 randomly. Get next property step 314 may decide to process the next date, if, as non-limiting examples, property 50 have been processed or only one property 50 was identified in get properties step 302. Get next property step 314 may not be executed, if, as non-limiting example, only one property 50 was retrieved in get properties step 302.

More properties decision 312 can be executed to determine the next step to be processed depending whether get next property step 314 identifies another property 50 to process. If there are more property 50, more properties decision 312 may decide to execute combination affected decision 308. If there are no more property 50, more properties decision 312 may decide to execute get next combination step 316. More properties decision 312 can, in some embodiments, use information from data store 104, if, for a non-limiting example, get next property step 314 does not provide the information needed to make this decision. In some embodiments, more properties decision 312 may not be executed, such as, for a non-limiting example, property 50 for assignment combination 52 can be processed in a single step.

Get next combination step 316 can be executed to determine the next assignment combination 52 to process in score combination step 310. Get next combination step 316 may use information retrieved in get combinations step 300, information from user interface 116, other information from data store 104, or other information to determine the next assignment combination 52 to be processed. Get next combination step 316 may, in some embodiments, select the next sequential assignment combination 52 identified in get combinations step 300. Get next combination step 316 may, in some embodiments, use information from user interface 116 to determine the next assignment combination 52, such as, for non-limiting examples, user interface 116 indicates to process weeks in a specific order, to process participant 922 in a specific order, or other applicable criteria. In some embodiments, get next combination step 316 may select the next assignment combination 52 randomly. Get next combination step 316 may not be executed, if, as non-limiting example, only one assignment combination 52 was retrieved in get combinations step 300.

More combinations decision 318 can be executed to determine the next step to be processed depending whether get next combination step 316 identified another assignment combination 52 to process. If there are more assignment combination 52, more combinations decision 318 can execute get first property 306. If there are no more assignment combination 52, more combinations decision 318 can determine that score combinations operation 134 is done 320. More combinations decision 318 can, in some embodiments, use information from data store 104, if, for a non-limiting example, get next combination step 316 does not provide the information needed to make this decision. In some embodiments, more combinations decision 318 may not be executed, such as, for a non-limiting example, assignment combination 52 can be processed in a single step.

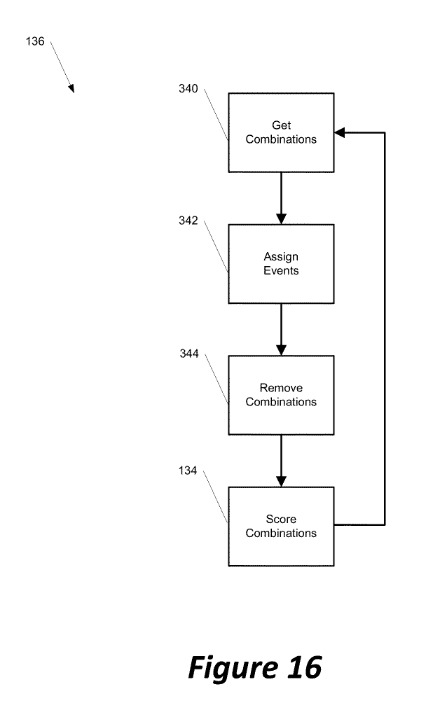

Referring again to FIG. 11, in the assign events operation 136, the schedule management system 102 determines the highest priority assignment combination 52 and assign event 46 to participant 22. An example of the assign events operation 136 is described in more detail with reference to FIG. 16.

FIG. 16 illustrates an exemplary flow of the assign events operation 136, which may include a plurality of steps, such as get combinations step 340, assign events step 342, remove combinations step 344, and score combinations operation 134. After assignment, the schedule management system 102 can execute the score combination operation 134 and continue processing until assignment combination 52 have all been processed or other reason to complete 346 processing. In some embodiments, when more than one assignment combination 52 has the same priority, scheduling process 122 can, as non-limiting examples, select assignment combination 52 randomly; or select assignment combination 52 using other available criteria, such as, for non-limiting examples, entity property data 154, facility data 170 priority detail not illustrated, team data 162 priority detail not illustrated, or other available information. The schedule management system 102 can, in some embodiments, maintain assignment 48 within data store 104. In some embodiments, assign events operation 136 may contain more or fewer steps. In some embodiments, assign events operation 136 can share information between steps by, as non-limiting examples, passing information from one step to another, passing keys from one step to another, storing information in data store 104 for retrieval by the next step, or other operation for passing information between steps.

Get combinations step 340 can be executed to determine assignment combination 52 that should be considered for assignment 48 to participant 22. Get combinations step 340 can, in some embodiments, select highest score assignment combination 52 using scores calculated in score combinations operation 134. Get combinations step 340 can, in some embodiments, select assignment combination 52 randomly. If get combinations step 340 selects more than one assignment combination 52 using selection criteria, then it can use additional information for tie breaking, such as, for non-limiting examples, entity property data 154, participant data 168 priority detail not illustrated, facility data 170 priority detail not illustrated, association data 164 priority detail not illustrated, or other available information to select assignment combination 52. In some embodiments, get combinations step 340 can return multiple assignment combination 52 to be assigned, such as, for non-limiting examples, multiple assignment combination 52 associated with shared event 46, assignment combination 52 with the same priority, assignment combination 52 that are for different event 46, or other possible selection criteria. In some embodiments, get combinations step 340 may not be executed, such as, for non-limiting example, available assignment combination 52 are processing in a single step.

Assign events step 342 can be executed to use assignment combination 52 selected in get combinations step 340 to assign event 46 identified in assignment combination 52 to participant 22 identified in assignment combination 52. Assign events step 342 can store assignment 48 in assignment data 158 in data store 104, including, as non-limiting examples, the following details: unique event 46 id, unique participant 22 id, activity 44, duration 42, assignment combination 52 score, unique assignment combination 52 id, or other appropriate information. In some embodiments, assign events step 342 can maintain assignment 48 to be confirmed using user interface 116 before storing in assignment data 158.

Remove combinations step 344 can be executed to update available combination 52 based on event 46 assigned in assign events step 342. Remove combinations step 344 can retrieve additional information from data store 104 to determine if assignment combination 52 should be removed, such as, for non-limiting example, a maximum events per day entity property 54, an overlapping events allowed entity property 54, other applicable entity property data 154, or other available information. Remove combinations step 344 can, for non-limiting examples, remove other assignment combination 52 for event 46 assigned in assign events step 342, remove assignment combination 52 on the same day for participant 22 assigned using a maximum event 46 per day entity property 54, remove assignment combination 52 for participant 22 assigned that overlap with event 46 assigned using an overlapping assignment 48 allowed entity property 54, or other applicable removal criteria. In some embodiments, remove combinations step 344 can be executed with score combinations operation 134 to determine the score and remove applicable assignment combination 52 in a single step. Remove combinations step 344 can, in some embodiments, be executed against zero, one, or more assignment combination 52 using appropriate selection criteria.

The score combinations operation 134 can be executed to calculate assignment combination 52 scores after event 46 have been assigned. Score combinations operation 134 can, in some embodiments, limit assignment combination 52 selected for processing to those that may have been included in assignment 48, such as, for non-limiting examples, assignment combination 52 for participant 22 for the last assignment 48, assignment combination 52 for event 46 assigned, assignment combination 52 for facility 10 for event 46 assigned, assignment combination 52 for activity 44 for event 46 assigned, or other available criteria. Score combinations operation 134 can, in some embodiments, update zero, one, or more assignment combination 52 using the selection criteria. Score combinations operation 134 can, in some embodiments, be executed with remove combinations step 344. Score combinations operation 134 can, in some embodiments, execute get combinations step 340 next to create a loop for processing available assignment combination 52. Score combinations operation 134 can, in some embodiments, display user interface 116 to allow for confirmation of assignment 48 before processing another assignment combination 52 not illustrated.

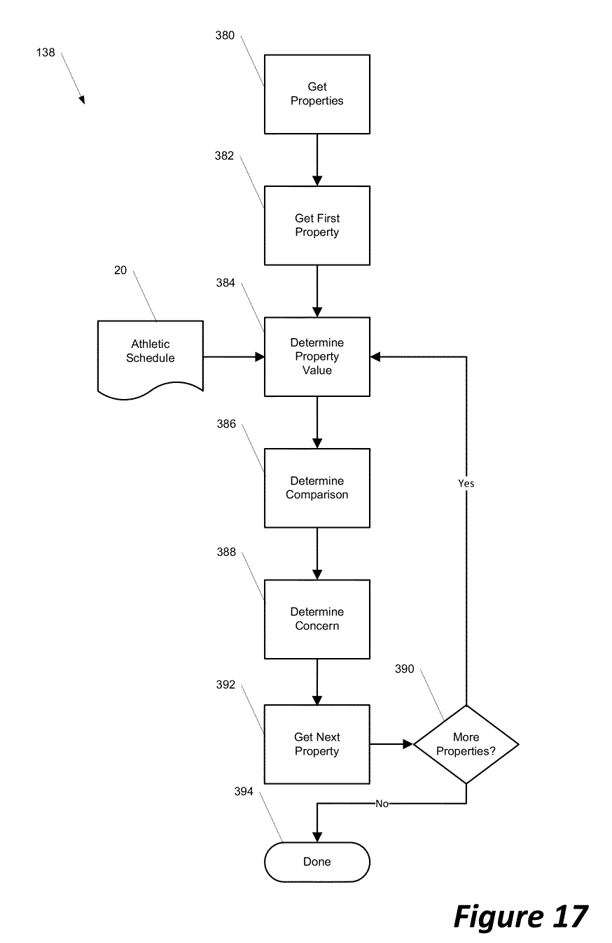

Returning to FIG. 11, the audit assignments operation 138 uses entity property data 154 and assignment data 158, and provide a comparison of audit data 156 participant 22 value detail and entity property data 154 setting detail. The audit assignments operation 138 is described in more detail with reference to FIG. 17.

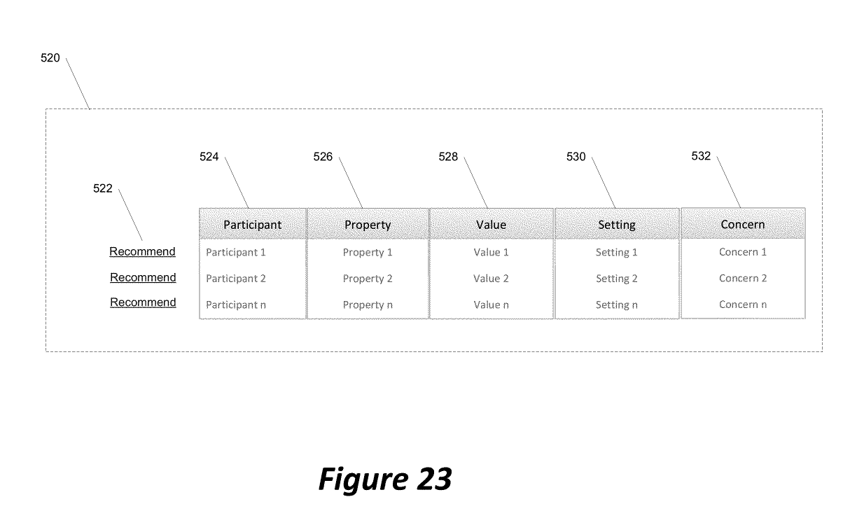

FIG. 17 illustrates an exemplary flow of the audit assignments operation 138, which includes a plurality of steps, such as get properties step 380, get first property step 382, determine property value step 384, input athletic schedule 20, determine comparison step 386, determine concern step 388, get next property step 392, and more properties decision 390. The schedule management system 102 can, in some embodiments, evaluate audit data 156 participant 22 value detail and entity property data 154 setting detail to determine a concern value as a review priority. The audit assignments operation 138 can, in some embodiments, store comparisons from audit assignments operation 138 within data store 104 not illustrated. In some embodiments, audit assignments operation 138 may contain more or fewer steps. In some embodiments, audit assignments operation 138 can share information between steps by, as non-limiting examples, passing information from one step to another, passing keys from one step to another, storing information in data store 104 for retrieval by the next step, or other operation for passing information between steps. An example assignment audit user interface is illustrated later with reference to FIG. 23.

With continued reference to FIG. 17, get properties step 380 can be executed to retrieve applicable property data 152 to be included in audit assignments operation 138. Get properties step 380 may retrieve one or more applicable property 50 from property data 152 in data store 104, including, as non-limiting examples, event 46 count property 50, required event 46 property 50, day of week required property 50, event 46 run property 50, event 46 gap property 50, or other applicable property 50 that can be included in audit assignments operation 138. In some embodiments, get properties step 380 can select property data 152 that can be used only for audit assignments operation 138, for audit assignments operation 138 and assign events operation 136, or only assign events operation 136, such as, for non-limiting examples, a monthly event 46 count property 50 is used for assign events operation 136, but audit assignments operation 138 is not executed for this property 50. In some embodiments, get properties step 380 can obtain one or more details from user interface 116, such as, for non-limiting examples, activity data 168 detail, facility data 170 detail, association data 164 detail, team data 162 detail, or other detail that may be used to determine applicable property data 152, such as, for a non-limiting example, user interface 116 may indicate that all practice activity 44 property 50 should be included in audit assignments operation 138.

Get first property step 382 can be executed to get the first property 50 to be processed from get properties step 380. Get first property step 382 may, in some embodiments, receive property data 152 directly from get properties step 380. Get first property step 382 can, in some other embodiments, retrieve property data 152 from data store 104. In some embodiments, get first property step 382 may not be executed if, as non-limiting examples, property 50 retrieved from get properties step 380 can be processed in a single step, or there is only one property 50 identified in get properties step 380.

Determine property value step 384 can be executed using input athletic schedule 20 to determine audit data 156 participant 22 value detail for applicable entity property 54. Determine property value step 384 can review input athletic schedule 20 to calculate a numeric value for, as non-limiting examples, event 46 count, event 46 gap, event 46 run, event 46 existence, event 46 absence, or other applicable values. In some embodiments, property 50 value calculated can be, as non-limiting examples, integers, decimals, letters, or other data type that can be compared against other values. In some embodiments, determine property value step 384 can calculate one or more audit data 156 participant 22 values from athletic schedule 20, such as, for a non-limiting example, a weekly event 46 count property 50 can generate a value for each week included in athletic schedule 20. Determine property value step 384 can, in some embodiments, store calculated audit data 156 participant 22 value in data store 104 within audit data 156. In some embodiments, determine property value step 384 can calculate a value for participant 22 even if there is no entity property 54 defined. In some embodiments, determine property value step 384 can calculate a value in audit data 156 based on assignment 48 that may not be present in athletic schedule 20, such as, for a non-limiting example, entity property data 154 indicates that participant 22 is required to have event 46 on a Tuesday and no such assignment 48 is found in athletic schedule 20. Determine property value step 384 may not be executed, such as, for a non-limiting example, property 50 value is stored in data store 104 from a previous execution of determine property value step 384.

Determine comparison step 386 can be executed to compare audit data 156 participant 22 value calculated in determine property value step 384 against entity property 54 setting stored in entity property data 154. Determine comparison step 386 can calculate a numeric variance between audit data 156 participant 22 value and entity property 54 setting. Determine comparison step 386 can, in some embodiments, not be executed, if, for a non-limiting example, property 50 being processed requires an assignment 48, in which case there may not be property 50 setting to compare against. Determine comparison step 386 can, in some embodiments, store the calculated numeric variance in data store 104, such as, for a non-limiting example, within an audit data 156 variance detail not illustrated. Determine comparison step 386 can, in some embodiments, display the property variance using user interface 116. Determine comparison step 386 can, in some embodiments, receive entity property 54 setting from user interface 116 for comparison against audit data 156 participant 22 value detail calculated in determine property value step 384.

Determine concern step 388 can be executed to assign a priority to the variance calculated in determine comparison step 386. Concern identified can be a numeric, string or other appropriate data type, such as, for non-limiting examples, review, none, ignore, 1, 2, high, medium, low, or other value. Determine concern step 388 can, in some embodiments, assign concern based on the significance of the variance, such as, for non-limiting examples, a zero variance may receive an ignore concern, a negative variance may receive a review concern, and a positive variance may receive a none concern. Determine concern step 388 may not be executed, for non-limiting examples, concerns can be determined within determine comparison step, or the variance is used instead of concern. In some embodiments, determine concern step 388 can store concern value identified in data store 104, such as, for a non-limiting example, within audit data 156 concern detail.

Get next property step 392 can be executed to determine next property 50 to process in determine property value stop 384. Get next property step 392 may use information obtained in get properties step 380, information from user interface 116, other information from data store 104, or other information from user interface 116 to determine next property 50 to be processed. Get next property step 392 may, in some embodiments, select next sequential property 50 obtained from get properties step 380. Get next property step 392 may, in some embodiments, use information from user interface 116 to determine next property 50, such as, for a non-limiting example, user interface 116 indicates to process event 46 count property 50 before processing other property 50. In some embodiments, get next property step 392 may select next property 50 randomly. Get next property step 392 may not be executed, if, as a non-limiting example, only one property 50 was retrieved in get properties step 380.

More properties decision 390 can be executed to determine the next step to be processed depending whether get next property step 392 identified another property 50 to process. If there are more property 50, more properties decision 390 can execute determine property value step 384. If there are no more property 50, more properties decision 390 can, in some embodiments, be done 394. More properties decision 390 can, in some embodiments, use information from data store 104, if, for a non-limiting example, get next property step 392 does not provide the information needed to make a decision. In some embodiments, more properties decision 390 may not be executed, such as, for a non-limiting example, property 50 can be processed in a single step.

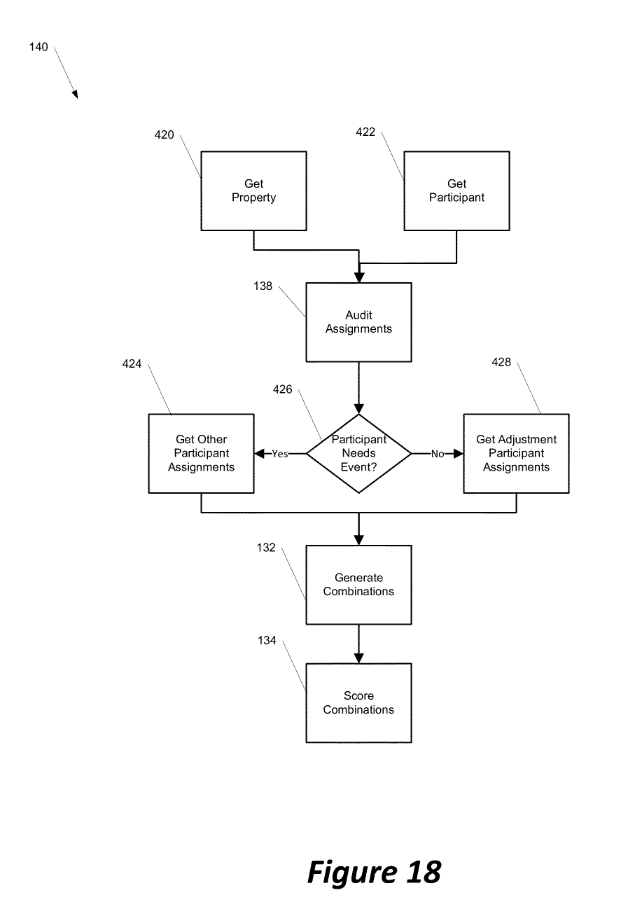

Returning to FIG. 11, the recommend adjustments operation 140 prioritizes changes requested after athletic schedule 20 has been generated and update assignment data 48 with selected recommendations. The detailed operations is described in FIG. 18.

FIG. 18 illustrates an exemplary flow of the recommend adjustments operation 140, which includes a plurality of steps, such as get participant step 422, get property step 420, audit assignments operation 138, participant needs event decision 426, get other participant assignments 424, get adjustment participant assignments 428, generate combinations 132, and score combinations 134. Recommended adjustments can include, as non-limiting examples, removing an assignment 48, adding a new assignment 48, swapping assignment 48 between participant 22, changing the start time of an assignment 48, change facility 10 for assignment 48, change duration 42 of assignment 48, or other possible assignment 48 changes. The schedule management system 102 can select applicable property 50 and assignment 48 to generate an appropriate set of recommendations that can be used to adjust athletic schedule 20. User interface 116 can, in some embodiments, be used to display recommendations. In some embodiments, recommend adjustments operation 140 can have more or fewer steps as those illustrated in FIG. 18. In some embodiments, recommend adjustments operation 140 can share information between steps by, as non-limiting examples, passing information from one step to another, passing keys from one step to another, storing information in data store 104 for retrieval by the next step, or other operation for passing information between steps.

Get participant step 422 can be executed to retrieve participant data 168 for participant 22 having assignment 48 adjusted. Get participant step 422, in some embodiments, can receive participant data 168 from user interface 116. Get participant step 422, in some embodiments, can receive one or more participant 22 for which to recommend adjustments. Get participant step 422, can, in some embodiments, loop through all property 50 available for audit not illustrated.

Get property step 420 can be executed to retrieve property data 152 and entity property data 154 for property 50 being adjusted. Get property step 420, in some embodiments, can receive property 50 information from user interface 116. Get property step 420, in some embodiments, can receive one or more property 50 to recommend adjustments. Get property step 420 can, in some embodiments, loop through all property 50 available for audit not illustrated.

Audit assignments operation 138 can be executed to determine audit data 156 participant 22 value detail and entity property data 154 setting detail for property 50 identified in get property step 420. In some embodiments, audit data 156 participant 22 value detail and entity property data 154 setting detail can be retrieved from data store 104 for a previous execution of audit assignments operation 138. In some embodiments, audit data 156 participant 22 value detail and entity property data 154 setting detail can be received from executing audit assignments operation 138.

Participant needs event decision 426 can be executed to determine if adjustment participant 22 needs more assignment 48 or fewer assignment 48 based on entity property 54 variance calculated in the audit assignments operation 138. For non-limiting examples, a negative variance on event 46 count entity property 54 can indicate that participant 22 needs more event 46 applicable to event 46 count entity property 54, or a positive variance on an event 46 count property 50 can indicate that participant 22 needs fewer event 46 applicable to event count entity property 54. Participant needs event decision 426 can decide to execute get other participants assignments step 424, if participant 22 needs more assignment 48, or participant needs event decision 426 can decide to execute get adjustment participant assignments 428, if participant 22 needs fewer assignment 48.

Get other participant assignments step 424 can be executed to identify assignment 48 for participant 22 other than participant 22 identified in get participant step 422. Get other participant assignments step 424 can identify adjustments that meet identified property 50 details, such as, for non-limiting examples, change other participant 22 assignment 48 to adjustment participant 22, swap other participant 22 assigned event 46 with one or more adjustment participant 22 assignment 48, or other appropriate adjustment. Get other participant assignments step 424 can retrieve assignment data 158 for event 46 applicable to property 50 identified in get property step 420. For a non-limiting example, if a Saturday event 46 count property 50 is being adjusted and participant 22 does not have enough Saturday event 46, get other participant assignments step 424 can retrieve Saturday assignment 48 for participant 22 other than participant 22 identified in get participant step 422 for consideration to be assigned to participant 22 being adjusted. In some embodiments, get other participant assignments step 424 can retrieve assignment 48 for both adjustment participant 22 and other participant 22, such as, for a non-limiting example, an early morning event 46 count property 50 is being adjusted and adjustment participant 22 does not have enough early morning event 46, get other participant assignments step 424 can retrieve adjustment participant 22 non-early morning event 46 and other participant 22 early morning event 46 for adjustment consideration.

Get adjustment participant assignments step 428 can be executed to identify applicable assignment 48 for adjustment participant 22 identified in get participant step 422. Get adjustment participant assignments step 428 can identify adjustments that meet identified property 50 details, such as, for non-limiting examples, change adjustment participant 22 assignment 48 to another participant 22, swap adjustment participant 22 assignment 48 with one or more other participant 22 assignment 48, change the start time for adjustment participant 22 assignment 48, change facility 10 for an adjustment participant 22 assignment 48, change duration 42 of adjustment participant 22 assignment 48, remove assignment 48 for adjustment participant 22, or other appropriate assignment 48 adjustment. Get adjustment participant assignments step 428 can retrieve assignment data 158 for event 46 applicable to property 50 identified in get property step 420. For a non-limiting example, if a Saturday event 46 count property 50 is being adjusted and participant 22 has too many Saturday event 46, get adjustment participant assignments step 428 can retrieve Saturday assignment 48 for adjustment participant 222 identified in get participant step 422 for consideration to be assigned to other participant 22 not being adjusted. In some embodiments, get adjustment participant assignments step 428 can retrieve assignment 48 for both adjustment participant 22 and other participant 22, such as, for a non-limiting example, an early morning event 46 count property 50 is being adjusted and adjustment participant 22 has too many early morning event 46, get adjustment participant assignments step 428 can retrieve adjustment participant 22 early morning event 46 and other participant 22 non-early morning event 46 for adjustment consideration.

Generate combinations operation 132 can be executed to determine appropriate assignment combination 52 based on recommended adjustment and assignment 48 retrieved in get other participant assignments step 424 or get adjustment participant assignments step 428. If generate combinations operation 132 processes event 46 received from get other participant assignments step 424, then generate combinations operation 132 can, as non-limiting examples, generate applicable assignment combination 52 for event 46 retrieved in get other participant assignments step 424 assigned to adjustment participant 22 for applicable activity 44, generate assignment combination 52 for swapping other participant 22 assignment 48 to adjustment participant 22 and adjustment participant 22 assignment 48 to another participant 22, or other applicable adjustment assignment combination 52. For a non-limiting example, a Saturday solo practice is retrieved for another participant 22 and assignment combination 52 for a solo practice and game may be generated for adjustment participant 22. If generate combinations operation 132 processes event 46 received from get adjustment participant assignments step 428, then generate combinations operation 132 can, as a non-limiting example, generate applicable assignment combination 52 for event 46 retrieved in get adjustment participant assignments step 428 assigned to other participant 22 for applicable activity 44. For a non-limiting example, a Saturday solo practice is retrieved for adjustment participant 22 and assignment combination 52 for a solo practice, game, or shared practice may be generated for one or more other participant 22. In some embodiments, generate combinations operation 132 may use more or fewer property 50 for determining appropriate assignment combination 52 to be considered, such as, for a non-limiting example, a maximum daily count property 50 may be ignored as assignment combination 52 can be evaluating participant 22 that already have assignment 48. In some embodiments, generate combinations operation 132 can retain links between assignment combination 52 that are related to one adjustment, such as, for a non-limiting example, two participant 22 assignment 48 are being swapped and each participant 22 has a separate assignment combination 52. In some embodiments, generate combinations operation 132 can maintain multiple event 46 adjustments within one assignment combination 52, such as, for a non-limiting example, participant 22 assignment 48 are being swapped and both assignment 48 adjustments are contained within one assignment combination 52.

Score combinations operation 134 can be executed to score assignment combination 52 identified in generate combinations operation 132. In some embodiments, score combinations operation 134 can calculate a total score for adjustments that involve multiple assignment combination 52 changes, such as, for a non-limiting example, if event 46 are swapped between two participant 22, adjustment total score can be calculated as two assignment combination 52 scores divided by two. In some embodiments, score combinations operation 134 can calculate the score for assignment combination 52 that contains multiple adjustments, such as, for a non-limiting example, a swap of assignment 48 between one or more participant 22.

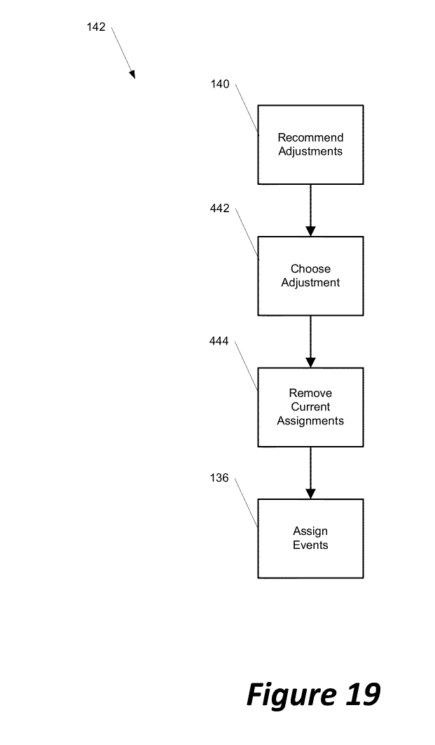

Returning to FIG. 11, the adjust schedule operation 142 takes input of recommended adjustment assignment combination 52, selects the appropriate assignment combination 52, and updates athletic schedule 20. The schedule management system 102 can execute audit assignments operation 138 after adjustments have been completed. The operation 142 is described in more detail with reference to FIG. 19.

FIG. 19 provides an exemplary illustration of the adjust schedule operation 142, which includes a plurality of steps, such as recommend adjustments step 140, choose adjustment step 442, remove current assignments step 444, and assign events operation 136. Adjust schedule operation 142, in some embodiments, can have more or fewer steps as those illustrated in FIG. 19. In some embodiments, adjust schedule operation 142 can share information between steps by, as non-limiting examples, passing information from one step to another, passing keys from one step to another, storing information in data store 104 for retrieval by the next step, or other operation for passing information between steps.

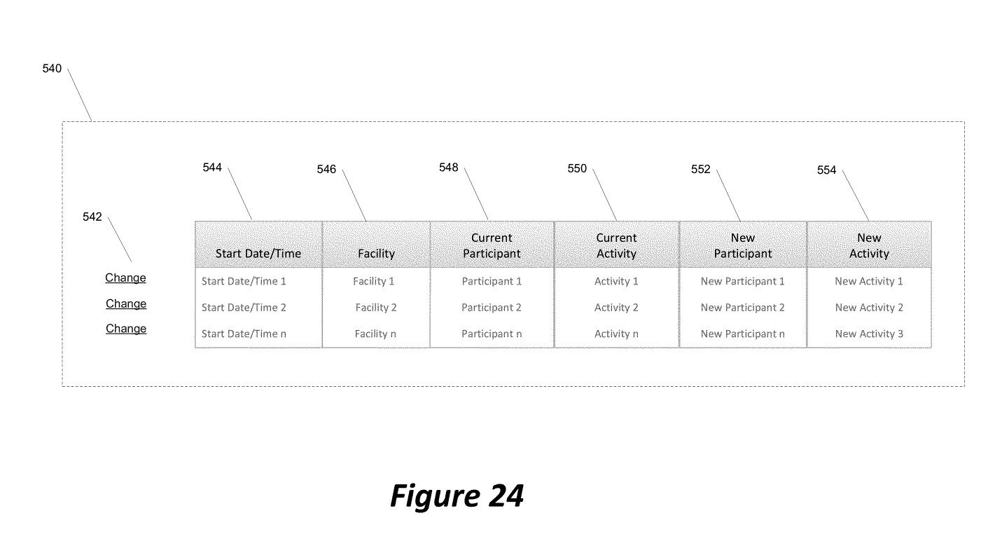

Choose adjustment step 442 can, in some embodiments, receive output from recommend adjustments operation 140 or other possible adjustments for entity property 54 being adjusted. Choose adjustment step 442, in some embodiments, can be executed within system 100 which can choose the adjustment to be completed using the score determined in recommend adjustments operation 140. Choose adjustment step 442, in some embodiments, can display output from recommend adjustments operation 140 using user interface 116 for selection of adjustment to be completed. Choose adjustment step 442 can, in some embodiments, complete zero, one, or more adjustments. Choose adjustment step 442 may not be executed, such as, for non-limiting examples, only one adjustment is identified, system 100 automatically selects the appropriate adjustment, or all available adjustments are processed. An example adjustment selection user interface 540 for capturing the selection of a recommended adjustment is illustrated in FIG. 24.

The remove current assignments step 444 can be executed to remove assignment 48 using the selected adjustment assignment combination 52 identified in recommend adjustments operation 140 or choose adjustment step 442. Remove current assignments step 444 can remove one or more assignment 48 from assignment data 158. Remove current assignments step 444 can remove assignment 48 from one or more participant 22 based on input assignment combination 52 from recommend adjustments operation 140 or choose adjustment step 442. In some embodiments, remove current assignments step 444 can remove zero, one, or more assignment 48 based on input assignment combination 52. In some embodiments, remove current assignments step 444 may not be executed, such as, for a non-limiting example, assignment combination 52 do not require any assignment 48 removals.

The assign events operation 136 can be executed to assign new event 46 using selected recommended adjustment assignment combination 52 identified in recommend adjustments operation 140 or choose adjustment step 442. Assign events operation 136 can assign zero, one, or more event 46 based on input assignment combination 52. Assign events operation 136 can create assignment 48 for zero, one, or more event 46 based on input assignment combination 52. In some embodiments, assign events operation 136 may not be executed, such as, for a non-limiting example, assignment combination 52 do not require assignment 48 to be created.

FIG. 20 illustrates an exemplary entity property user interface 460 for capturing entity property data 154 as part of define properties operation 124 within user interface 116. Entity property user interface 460 provides an apparatus, using system 100, for the entry, review, and update of entity property data 154. Entity property user interface 460, in some embodiments, can contain entity selection control 462 and property setting entry control 464. Entity selection control 462 provides a way to select entity 56 whose property data 152 can be displayed in property selection entry control 464. In some embodiments, entity selection 462 can, as non-limiting examples, display a list of team 14, association 12, or other entity 56 that may have property 50 to be defined. In some embodiments, entity selection 462 can be represented by a list box, text box, drop-down box, or other selection control available for user interfaces. In some embodiments, property setting entry 464 can be represented by a text box, a drop-down box, a list box, multiple list boxes, or other entry controls available for user interfaces. In some embodiments, property setting entry 464 can display a label with property data 152 name detail or other descriptive information. In some embodiments, entity property user interface 460 can display buttons not illustrated for creating, updating, or deleting entity property data 154. In some embodiments, entity property user interface 460 can display one or more entity property data 154. In some embodiments, entity property user interface 460 can be displayed with other information from data store 104 or other data sources. In some embodiments, entity property user interface 460 can display buttons, links, or other controls that navigate to other user interfaces.

FIG. 21 illustrates an exemplary obtain event user interface 480 for providing information from obtain events operation 130 to guide adjustment of event listing 240. As a non-limiting example, obtain event user interface 480 may contain date column 482, expected event count column 484, obtained event count column 486, and gap count column 488. Date column 482 can display the dates identified in get first date step 224 and get next date step 232 of obtain events operation 130. The expected event count column 484 can display event 46 count calculated in calculate events needed step 228 and total events needed step 234. In some embodiments, expected event count column 484 can be displayed as a decimal or integer regardless of what is calculated in the calculate events needed step 228 and total events needed step 234. Obtained event count column 486 can display actual event 46 obtained value calculated in compare against obtained events step 236. In some embodiments, obtained event count column 486 can be displayed as a decimal or integer regardless of what is calculated in compare against events obtained step 236. Gap count column 488 can display the variance calculated in compare against obtained events step 236 indicating whether more or fewer event 46 are needed. In some embodiments, gap count column 488 can be displayed as a decimal or integer regardless of what is calculated in compare against obtained events step 236. In some embodiments, obtain event user interface 480 may contain more or fewer controls to provide for adjusting event listing 240, such as, for non-limiting examples, display available event 46 from facility 10, display of links to accessible facility 10 systems for event 46 selection, or display of a user interface to enter one or more event 46 details. In some embodiments, obtain event user interface 480 may display additional criteria regarding event 46 needed, such as, for non-limiting examples, participant 22 data, facility data 170, event data 166, or other available information. In some embodiments, obtain event user interface 480 may display buttons or other controls that allow navigation to other user interfaces. In some embodiments, adjust event listing step 238 can display more or fewer columns than those illustrated in FIG. 21.

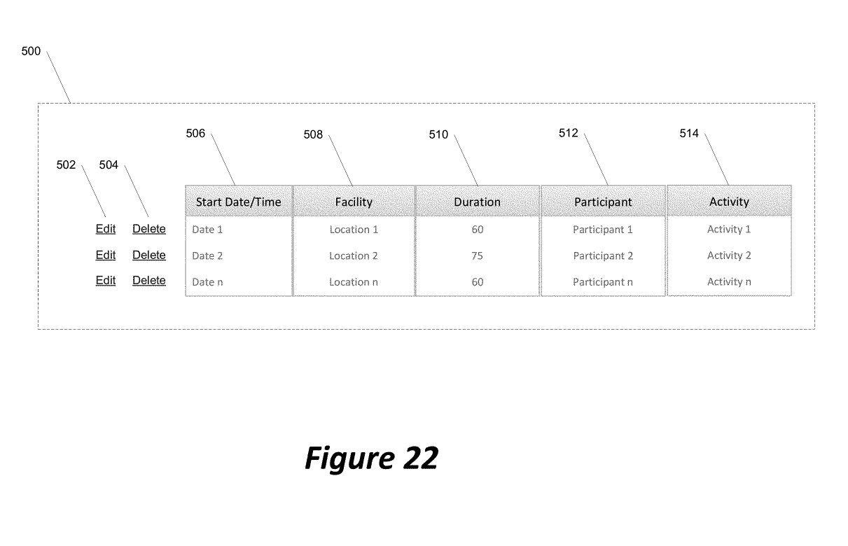

FIG. 22 illustrates an exemplary schedule management user interface 500 for athletic schedule 20, comprising edit link 502, delete link 504, start date/time column 506, facility column 508, duration column 510, participant column 512, and activity column 514. Edit link 502 can display a button, link, or other control that displays a user interface not illustrated for editing event 46 or assignment 48. Delete link 504 can display a button, link, or other control that can delete event 46 or assignment 48. Start date/time column 506 can display event data 166 start date detail and event data 166 start time detail. Facility column 508 can display details from facility data 170 that describe facility 10 for event 46. Duration column 510 can display event data 166 duration 42 detail that describes the length of event 46. Participant column 512 can display participant 22 assigned to event 46 within assignment data 158. Activity column 514 can display activity 44 associated with event 46 for participant 22 from assignment data 158 activity 44 detail. In some embodiments, schedule management interface 500 may contain more or fewer details, such as for non-limiting examples, a shared participant 22 detail, a cost detail, a day of week detail, or other appropriate detail. In some embodiments, schedule management interface 500 can display buttons, links, or other controls to navigate to other user interfaces. In some embodiments, schedule management interface 500 can display additional action links, such as, for non-limiting examples, paid, return, lock, or other appropriate action. In some embodiments, the order of the details displayed may vary.

FIG. 23 illustrates an exemplary assignment audit user interface 520 for displaying audit assignments operation 138 details. Assignment audit user interface 520 can comprise recommend link 522, participant column 524, property column 526, value column 528, setting column 530, and concern column 532. Recommend link 522 can display a button, link, or other control that allows for selection of a record for recommend adjustments operation 140. Participant 524 can display participant 22 details, such as, for a non-limiting example, participant 22 name. Property column 526 can display details from property data 152. Value column 528 can display audit data 156 participant 22 value detail that can, as non-limiting examples, be retrieved from data store 104 or be generated from audit assignments operation 138. Setting column 530 can display entity property data 154 property setting detail. Concern column 532 can display audit data 156 concern detail that can, as non-limiting examples, be retrieved from audit data 156 or be generated from audit assignments operation 136. In some embodiments, assignment audit user interface 520 may contain more or fewer details, such as for non-limiting examples, variance detail calculated in audit assignments operation 138 or a week detail for weekly property 50 that can have multiple values for each participant 22. In some embodiments, assignment audit user interface 520 can display buttons, links, or other controls to navigate to other user interfaces. In some embodiments, assignment audit user interface 520 can display additional action links in addition to recommend, such as, for non-limiting examples, ignore, an update link that executes audit assignments operation 138, or other appropriate action. In some embodiments, the order of the details or action links displayed can be varied.

FIG. 24 illustrates an exemplary adjustment selection user interface 540 for capturing the selection of a recommended adjustment. Adjustment selection interface 540, as a non-limiting example, displays a change link 542, start date/time column 544, facility column 546, current participant column 548, current activity column 550, new participant column 552, and new activity column 554. Change link 542 can display a button, link or other control that can be selected to choose the recommended adjustment to be completed. Start date/time column 544 can display start date/time 40 for event 46 that is to be adjusted. Facility column 546 can display the name or other facility data 170 detail for facility 10 associated with event 46 to be adjusted. Current participant column 548 can display participant 22 currently assigned to event 46. Current activity column 550 can display activity 44 current assigned to event 46 for participant 22. New participant column 552 can display participant 22 that is to be assigned to event 46 upon completion of adjustment. New activity column 554 can display activity 44 that is to be assigned to event 46 for new participant 22. Adjustment selection interface 540 can, in some embodiments, display more or fewer details. In some embodiments, adjustment selection interface 540 can display one or more rows for each assignment combination 52 depending on the number of adjustments needed for the each assignment combination. In some embodiments, adjustment selection interface 540 can display empty values if, as non-limiting examples, the value is not changing with adjustment; event 46 is being removed from current participant 22, so there is no new participant 22; event 46 is being assigned to new participant 22, and there is no current participant 22; or other appropriate reason for empty values. In some embodiments, adjustment selection interface 540 can be displayed with other appropriate user interfaces. In some embodiments, adjustment selection interface 540 can display buttons, link, or other navigation controls to display other appropriate user interfaces.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

What is claimed is:

1. A method of generating a schedule of one or more athletic facilities for two or more athletic participants, the method comprising:
receiving property data via a user interface of at least one computing device, the property data associated with at least one of the athletic facilities and the athletic participants, and the property data including at least identifications of the athletic facilities, one or more time slots for the athletic facilities, and identifications of the athletic participants;
storing the property data in the at least one computing device;
generating, using the at least one computing device, assignment data, the assignment data including one or more possible assignments of the athletic participants to at least one of the athletic facilities;
scoring, using the at least one computing device, each of the possible assignments;
assigning, using the at least one computing device, at least one time slot for at least one of the athletic facilities to at least one of the athletic participants based on the scores of the possible assignments, the assigned time slot being part of the schedule; and
providing the schedule to the at least one of the athletic participants.

2. The method of claim 1, wherein the property data include at least one of organization data, event data, and activity data.

3. The method of claim 1, wherein each of the possible assignments is defined based on at least one of the organization data, event data, and activity data.

4. The method of claim 1, wherein the athletic organization is at least one of an athletic facility and an athletic association.

5. The method of claim 4, wherein the athletic participant is at least one of the athletic association and an athletic team.

6. The method of claim 1, further comprising:
obtaining pre-occupied event data, the pre-occupied event data including events pre-occupied at the athletic facilities; and
generating, using the at least one computing device, event data based on the property data, the event data including possible events available for the athletic participant at the athletic organization,
wherein the pre-occupied event data and the event data are part of the assignment data.

7. The method of claim 1, further comprising:
comparing, using the at least one computing device, the property data with the schedule;
verifying, using the at least one computing device, that the schedule is compatible with the property data; and
generating, using the at least one computing device, audit data based on the verification.

8. The method of claim 7, further comprising:
adjusting, using the at least one computing device, the schedule based on the audit data.

9. The method of claim 8, wherein adjusting the schedule based on the audit data comprises:
generating, using the at least one computing device, one or more additional possible assignments of the athletic facilities to the athletic participant; and
updating, using the at least one computing device, the schedule with at least one of the additional possible assignments.

10. The method of claim 9, wherein adjusting the schedule based on the audit data further comprises:
scoring, using the at least one computing device, each of the additional possible assignments; and
assigning, using the at least one computing device, at least one event of the athletic facility to the athletic participant based on the scores of the additional possible assignments, the assigned event being part of the updated schedule.

11. A system for generating a schedule of an athletic organization for an athletic participant, the system comprising:
a processing device configured to control the system;
a user interface; and
a computer readable data storage device storing software instructions that, when executed by the processing device, cause the system to:
receive property data via the user interface, the property data associated with at least one of the athletic facilities and the athletic participants, and the property data including at least identifications of the athletic facilities, one or more time slots for the athletic facilities, and identifications of the athletic participants;
store the property data in the at least one computing device;
generate assignment data, the assignment data including one or more possible assignments of the athletic participants to at least one of the athletic facilities;
score each of the possible assignments;
assign at least one time slot for at least one of the athletic facilities to at least one of the athletic participants based on the scores of the possible assignments, the assigned event being part of the schedule; and
provide the schedule to the at least one of the athletic participants.

12. The system of claim 11, wherein the software instructions further cause the system to:
obtain pre-occupied event data, the pre-occupied event data including events pre-occupied at the athletic facilities; and
generate event data based on the property data, the event data including possible events available for the athletic participant at the athletic organization,
wherein the pre-occupied event data and the event data are part of the assignment data.

13. The system of claim 11, wherein the software instructions further cause the system to:
compare the property data with the schedule;
verify that the schedule is compatible with the property data; and
generate audit data based on the verification.

14. The system of claim 13, wherein the software instructions further cause the system to:
adjust the schedule based on the audit data.

15. The system of claim 14, wherein the software instructions further cause the system to:
generate one or more additional possible assignments of the athletic facilities to the athletic participant; and
update the schedule with at least one of the additional possible assignments.

16. The system of claim 15, wherein the software instructions further cause the system to:
score each of the additional possible assignments; and
assign at least one event of the athletic facility to the athletic participant based on the scores of the additional possible assignments, the assigned event being part of the updated schedule.

17. A method of generating a schedule of one or more athletic facilities for two or more athletic participants, the method comprising:
storing a database, the database containing data, the data at least including facility identifications, event identifications, activity identifications, and participant identifications;
retrieving the data from the database;
generating assignment data, the assignment data including one or more possible assignments of the athletic participants to at least one of the athletic facilities;
scoring each of the possible assignments;
populate the database with the score;
assigning at least one time slot for at least one of the athletic facilities to at least one of the athletic participants based on the scores of the possible assignments;
populating the database with the at least one time slot; and
generate a schedule including the at least one time slot.

18. The method of claim 17, further comprising:
comparing the data with the schedule;
verifying that the schedule is compatible with the data;
generating audit data based on the verification; and
populate the database with the audit data.

19. The method of claim 17, further comprising:
generating one or more additional possible assignments of the athletic facilities to the athletic participant; and
updating the schedule with at least one of the additional possible assignments.

20. The method of claim 19, further comprising:
scoring each of the additional possible assignments; and
assigning at least one event of the athletic facility to the athletic participant based on the scores of the additional possible assignments, the assigned event being part of the updated schedule.
